(19) United States
(12) Patent Application Publication
(10) Pub. No.: US 2019/0065476 A1
(43) Pub. Date: Feb. 28, 2019

(54) METHOD AND APPARATUS FOR TRANSLATING TEXT DISPLAYED ON DISPLAY

(71) Applicant: Samsung Electronics Co., Ltd., Gyeonggi-do (KR)

(72) Inventors: Hyun-Woong KWON, Daegu (KR); Keun-Soo KIM, Gyeongsangbuk-do (KR); Jae-Oong CHO, Gyeongsangbuk-do (KR); Jin-San KONG, Daegu (KR); Kun-Hee LEE, Daegu (KR); Yeun-Wook LIM, Daegu (KR)

(21) Appl. No.: 16/107,120

(22) Filed: Aug. 21, 2018

(30) Foreign Application Priority Data
Aug. 22, 2017 (KR) 10-2017-0106355

(51) Int. Cl. G06F 17/28; G06F 3/0488; G06F 17/27; G06F 17/21; G06F 3/0482; G06F 3/0354

(52) U.S. Cl. CPC G06F 17/28; G06F 3/0488; G06F 17/2775; G06F 3/03545; G06F 17/21; G06F 3/0482; G06F 17/277

(57) ABSTRACT

Embodiments of the disclosure relate to methods for recognizing characters displayed on a display and devices for supporting the same. According to an embodiment, an electronic device may comprise a housing, a touchscreen display exposed through a portion of the housing, a processor electrically connected to the touchscreen display, and a memory electrically connected with the processor, wherein the memory may store instructions to, when the electronic device is operated, enable the processor to display a user interface including text having a plurality of words, detect a first position of an external object on or adjacent the touchscreen display, determine a single word at least partially based on the first position, provide a translation of the single word in a first mode, detect a second position of the external object on or adjacent the touchscreen display, determine two or more words at least partially based on the second position, and provide a translation of the two or more words in a second mode.

### CROSS-REFERENCE TO RELATED APPLICATION(S)

This application is based on and claims priority under 35 U.S.C. § 119 to Korean Patent Application No. 10-2017-0106355, filed on Aug. 22, 2017, in the Korean Intellectual Property Office, the disclosure of which is incorporated by reference herein in its entirety.

### BACKGROUND

### 1. Field

Embodiments of the disclosure generally relate to methods for translating text displayed on displays and devices for providing the same.

### 2. Description of Related Art

Developments of text recognition technology have led to the advent of translation services where an electronic device may automatically recognize text displayed on its screen and translate the text into the user's desired language.

Text recognition refers to a technique that enables a processor of an electronic device to automatically recognize text displayed or entered on the display of the electronic device, and this may be implemented using various techniques such as pattern matching and structure analysis. Pattern matching is primarily used for recognizing printed text, and structure analysis is used for recognizing handwritten text. In addition, other techniques such as feature matching and stroke analysis may also be used in conjunction with pattern matching and structure analysis.

### SUMMARY

To recognize text displayed on the display of an electronic device, optical character recognition (OCR) may be applied. OCR generally means capturing a person's handwritings or machine-printed text as images using a piece of optical equipment (e.g., a camera or scanner) and converting the images into machine-readable text. Conventional OCR schemes read text from images and may not precisely distinguish between similar-looking characters, such as the lowercase “1,” the upper case “I,” and the number “1,” thus oftentimes will include recognition errors. These recognition errors may in turn cause additional translation errors when OCR'ed text is used as the input for translation.

The above information is presented as background information only to assist with an understanding of the disclosure. No determination has been made, and no assertion is made, as to whether any of the above might be applicable as prior art with regard to the disclosure.

According to an embodiment, there may be provided a method for recognizing characters displayed on the display of an electronic device using various text-recognition techniques and determining all or part of the target text for translation, and particularly, a method for determining a translation target based on the position of an external object.

According to an embodiment, an electronic device may comprise a housing, a touchscreen display exposed through a portion of the housing, a processor electrically connected to the touchscreen display, and a memory electrically connected with the processor, wherein the memory may store instructions to, when the electronic device is operated, enable the processor to display a user interface including text having a plurality of words, detect a first position of an external object on or adjacent the touchscreen display, determine a single word at least partially based on the first position, provide a translation of the single word in a first mode, detect a second position of the external object on or adjacent the touchscreen display, determine two or more words at least partially based on the second position, and provide a translation of the two or more words in a second mode.

According to an embodiment, a method for recognizing a character displayed on a display of an electronic device may comprise displaying a user interface including text having a plurality of words, detecting a first position of an external object on or adjacent the display, determining a single word at least partially based on the first position, providing a translation of the single word in a first mode, detecting a second position of the external object on or adjacent the display, determining two or more words at least partially based on the second position, and providing a translation of the two or more words in a second mode.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a block diagram illustrating an electronic device in a network environment 100 according to an embodiment;

FIG. 2 is a block diagram illustrating the display device according to an embodiment;

FIG. 3 is a block diagram illustrating a program according to an embodiment;

FIG. 4 is a view illustrating a method for selecting a single word the selected word using an electronic device according to an embodiment;

FIG. 5 is a view illustrating a method in which an electronic device executes a single word translation mode or a sentence translation mode for two or more words, according to an embodiment;

FIG. 6 is a view illustrating a method in which an electronic device selects a sentence or paragraph as a translation target according to an embodiment;

FIG. 7 is a flowchart illustrating a method for imaging text using an OCR scheme, according to an embodiment;

FIG. 8 is a view illustrating a method in which an electronic device recognizes image-type text using an OCR scheme according to an embodiment;

FIG. 9 is a view illustrating a method in which an electronic device recognizes at least one word using an OCR scheme according to an embodiment;

FIG. 10 is a view illustrating a method in which an electronic device recognizes at least one sentence using an OCR scheme according to an embodiment;

FIG. 11 is a flowchart illustrating a method in which an electronic device recognizes characters using an OCR scheme and a text-extracting scheme and corrects mis-recognized characters, according to an embodiment;

FIG. 12 is a view illustrating a method in which an electronic device recognizes a sentence using an OCR scheme and a text extracting scheme and corrects mis-recognized content in the sentence according to an embodiment;

FIG. 13 is a view illustrating an example of comparing when an electronic device extracts text using both an OCR scheme and a text-extracting scheme with when the electronic device extracts text using the OCR scheme alone, according to an embodiment;

FIG. 14A and FIG. 14B are flowcharts illustrating a method in which an electronic device recognizes at least one character displayed on a display, according to an embodiment;

FIG. 15A and FIG. 15B are views illustrating a method in which an electronic device translates a currency unit or measuring unit according to an embodiment;

FIG. 16 is a flowchart illustrating a method for translating text displayed on a display of an electronic device 101 according to an embodiment; and

FIG. 17A and FIG. 17B, respectively, are a front perspective view and a rear perspective view illustrating an electronic device 101 according to an embodiment.

Throughout the drawings, like reference numerals will be understood to refer to like parts, components, and structures.

### DETAILED DESCRIPTION

Hereinafter, embodiments of the disclosure are described with reference to the accompanying drawings.

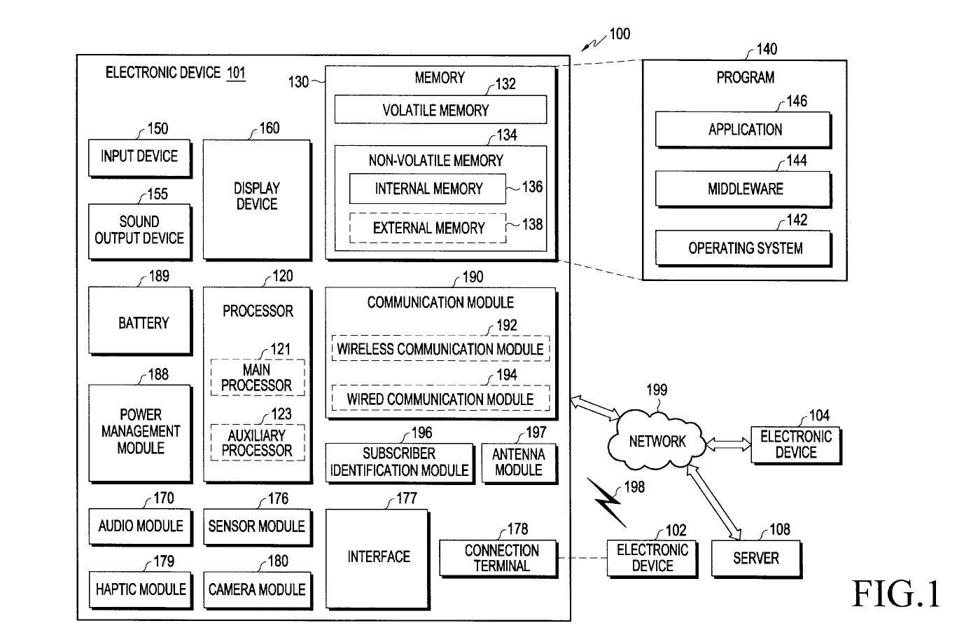

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module 196, and an antenna module 197. In some embodiments, the electronic device 101 may exclude at least one (e.g., the display device 160 or the camera module 180) of the components or add other components. In some embodiments, some components may be implemented to be integrated together, e.g., as if the sensor module 176 (e.g., a fingerprint sensor, an iris sensor, or an illuminance sensor) is embedded in the display device (160) (e.g., a display).

The processor 120 may be driven by software (e.g., a program 140) to control at least one other component (e.g., a hardware or software component) of the electronic device 101 connected with the processor 120 and may process or compute various data. The processor 120 may load and process command or data received from another component (e.g., the sensor module 176 or the communication module 190) on a volatile memory 132, and the processor 120 may store resultant data in a non-volatile memory 134. According to an embodiment, the processor 120 may include a main processor 121 (e.g., a central processing unit (CPU) or an application processor), and additionally or alternatively, an auxiliary processor 123 (e.g., a graphics processing unit (GPU), an image signal processor, a sensor hub processor, or a communication processor) that is operated independently from the main processor 121 and that consumes less power than the main processor 121 or is specified for a designated function. Here, the auxiliary processor 123 may be operated separately from or embedded in the main processor 121.

In such case, the auxiliary processor 123 may control at least some of functions or states related to at least one (e.g., the display device 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., performing an application). According to an embodiment, the auxiliary processor 123 (e.g., an image signal processor or a communication processor) may be implemented as part of another component (e.g., the camera module 180 or the communication module 190) functionally related to the auxiliary processor 123. The memory 130 may store various data used by at least one component (e.g., the processor 120) of the electronic device 101, e.g., software (e.g., the program 140) and input data or output data for a command related to the software. The memory 130 may include the volatile memory 132 or the non-volatile memory 134.

The program 140, as software stored in the memory 130, may include, e.g., an operating system (OS) 142, middleware 144, or an application 146.

The input device 150 may be a device for receiving a command or data, which is to be used for a component (e.g., the processor 120) of the electronic device 101, from an outside (e.g., a user) of the electronic device 101. The input device 150 may include, e.g., a microphone, a mouse, or a keyboard.

The sound output device 155 may be a device for outputting sound signals to the outside of the electronic device 101. The sound output device 155 may include, e.g., a speaker which is used for general purposes, such as playing multimedia or recording and playing, and a receiver used for call receiving purposes only. According to an embodiment, the receiver may be formed integrally or separately from the speaker.

The display 160 may be a device for visually providing information to a user of the electronic device 101. The display device 160 may include, e.g., a display, a hologram device, or a projector and a control circuit for controlling the display, hologram device, or projector. According to an embodiment, the display device 160 may include touch circuitry or a pressure sensor capable of measuring the strength of a pressure for a touch.

The audio module 170 may convert a sound into an electrical signal and vice versa. According to an embodiment, the audio module 170 may obtain a sound through the input device 150 or output a sound through the sound output device 155 or an external electronic device (e.g., an electronic device 102 (e.g., a speaker or a headphone) via a wire or wirelessly connected with the electronic device 101.

The sensor module 176 may generate an electrical signal or data value corresponding to an internal operating state (e.g., power or temperature) or external environmental state of the electronic device 101. The sensor module 176 may include, e.g., a gesture sensor, a gyro sensor, an atmospheric pressure sensor, a magnetic sensor, an acceleration sensor, a grip sensor, a proximity sensor, a color sensor, an infrared (IR) sensor, a bio sensor, a temperature sensor, a humidity sensor, or an illuminance sensor.

The interface 177 may support a designated protocol enabling a wired or wireless connection with an external electronic device (e.g., the electronic device 102). According to an embodiment, the interface 177 may include a high definition multimedia interface (HDMI), a universal serial bus (USB) interface, a secure digital (SD) card interface, or an audio interface. A connecting terminal 178 may include a connector, e.g., an HDMI connector, a USB connector, an SD card connector, or an audio connector (e.g., a headphone connector), which is able to physically connect the electronic device 101 with an external electronic device (e.g., the electronic device 102).

The haptic module 179 may convert an electrical signal into a mechanical stimulus (e.g., a vibration or a movement) or electrical stimulus which may be recognized by a user via his tactile sensation or kinesthetic sensation. The haptic module 179 may include, e.g., a motor, a piezoelectric element, or an electric stimulator.

The camera module 180 may capture a still image or moving images. According to an embodiment, the camera module 180 may include one or more lenses, an image sensor, an image signal processor, or a flash.

The power management module 188 may be a module for managing power supplied to the electronic device 101. The power management module 188 may be configured as at least part of, e.g., a power management integrated circuit (PMIC).

The battery 189 may be a device for supplying power to at least one component of the electronic device 101. The battery 189 may include, e.g., a primary cell which is not rechargeable, a secondary cell which is rechargeable, or a fuel cell.

The communication module 190 may support establishing a wired or wireless communication channel between the electronic device 101 and an external electronic device (e.g., the electronic device 102, the electronic device 104, or the server 108) and performing communication through the established communication channel. The communication module 190 may include one or more communication processors that are operated independently from the processor 120 (e.g., an application processor) and supports wired or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of the wireless communication module 192 and the wired communication module 194 may be used to communicate with an external electronic device through a first network 198 (e.g., a short-range communication network, such as Bluetooth, wireless-fidelity (Wi-Fi) direct, or infrared data association (IrDA)) or a second network 199 (e.g., a long-range communication network, such as a cellular network, the Internet, or a communication network (e.g., LAN or wide area network (WAN)). The above-enumerated types of communication modules 190 may be implemented in a single chip or individually in separate chips.

According to an embodiment, the wireless communication module 192 may differentiate and authenticate the electronic device 101 in the communication network using user information stored in the subscriber identification module 196.

The antenna module 197 may include one or more antennas for transmitting or receiving a signal or power to/from an outside. According to an embodiment, the communication module 190 (e.g., the wireless communication module 192) may transmit or receive a signal to/from an external electronic device through an antenna appropriate for a communication scheme.

Some of the above-described components may be connected together through an inter-peripheral communication scheme (e.g., a bus, general purpose input/output (GPIO), serial peripheral interface (SPI), or mobile industry processor interface (MIPI)), communicating signals (e.g., commands or data) therebetween.

According to an embodiment, commands or data may be transmitted or received between the electronic device 101 and the external electronic device 104 via the server 108 coupled with the second network 199. The first and second external electronic devices 102 and 104 each may be a device of the same or a different type from the electronic device 101. According to an embodiment, all or some of operations executed on the electronic device 101 may be run on one or more other external electronic devices. According to an embodiment, when the electronic device 101 should perform a certain function or service automatically or at a request, the electronic device 101, instead of, or in addition to, executing the function or service on its own, may request an external electronic device to perform at least some functions associated therewith. The external electronic device receiving the request may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used, for example.

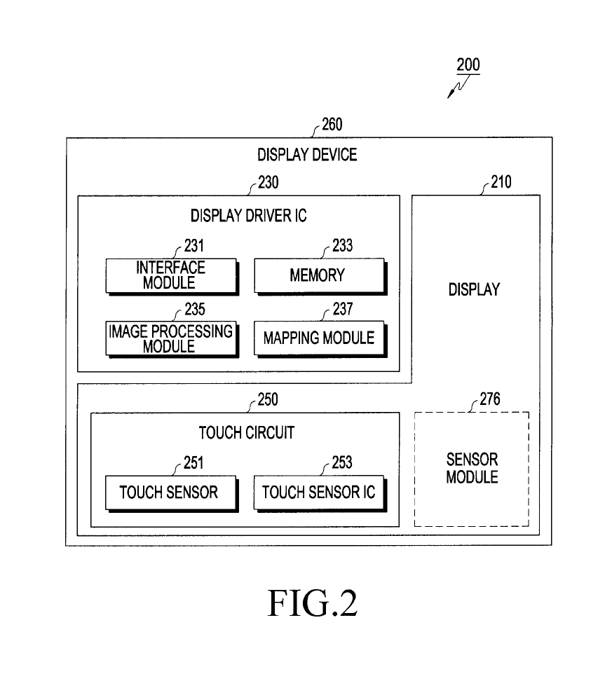

FIG. 2 is a block diagram 200 illustrating the display device 160 according to an embodiment. Referring to FIG. 2, the display device 160 may include a display 210 and a display driver integrated circuit (DDI) 230 to control the display 110. The DDI 230 may include an interface module 231, memory 233 (e.g., buffer memory), an image processing module 235, or a mapping module 237. The DDI 230 may receive image information that contains image data or an image control signal corresponding to a command for controlling the image data from the processor 120 (e.g., the main processor 121 (e.g., an application processor) or the auxiliary processor 123 operated independently from the function of the main processor 121) through, e.g., the interface module 231. The DDI 230 may communicate, for example, with touch circuitry 250 or the sensor module 176 via the interface module 231. The DDI 230 may also store at least part of the received image information in the memory 233, for example, on a frame by frame basis. The image processing module 235 may perform pre-processing or post-processing (e.g., adjustment of resolution, brightness, or size) with respect to at least part of the image data.

According to an embodiment, the pre-processing or post-processing may be performed, for example, based at least in part on one or more characteristics of the image data or one or more characteristics of the display 210. The mapping module 237 may convert the image data pre- or post-processed by the image processing module 235 into a voltage value or current value at which pixels of the display 210 may be driven, based on, at least, at least part of attributes of the pixels (e.g., the array (RGB stripe or pentile)) of the pixels or the size of each subpixel). At least some pixels of the display 210 may be driven based on, e.g., the voltage value or current value so that visual information (e.g., text, image, or icon) corresponding to the image data may be displayed on the display 210.

According to an embodiment, the display device 160 may further include the touch circuitry 250. The touch circuitry 250 may include a touch sensor 251 and a touch sensor IC 253 to control the touch sensor 151. The touch sensor IC 253 may control the touch sensor 251, sense a touch input or hovering input at a particular position of the display 210, e.g., by measuring a variation in a signal (e.g., a voltage, quantity of light, resistance, or quantity of electric charge) for the particular position of the display 210, and provide information (e.g., the position, area, pressure, or time) regarding the sensed touch input or hovering input to the processor 120. According to an embodiment, at least part (e.g., the touch sensor IC 253) of the touch circuitry 250 may be formed as part of the display 210 or the DDI 230, or as part of another component (e.g., the auxiliary processor 123) disposed outside the display device 160.

According to an embodiment, the display device 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display 210, the DDI 230, or the touch circuitry 250)) of the display device 160. For example, when the sensor module 176 embedded in the display device 160 includes a biometric sensor (e.g., a fingerprint sensor), the biometric sensor may obtain biometric information (e.g., a fingerprint image) corresponding to a touch input received via a portion of the display 210. As another example, when the sensor module 176 embedded in the display device 160 includes a pressure sensor, the pressure sensor may obtain pressure information corresponding to a touch input received via a partial or whole area of the display 210. According to an embodiment, the touch sensor 251 or the sensor module 176 may be disposed between pixels in a pixel layer of the display 210, or over or under the pixel layer.

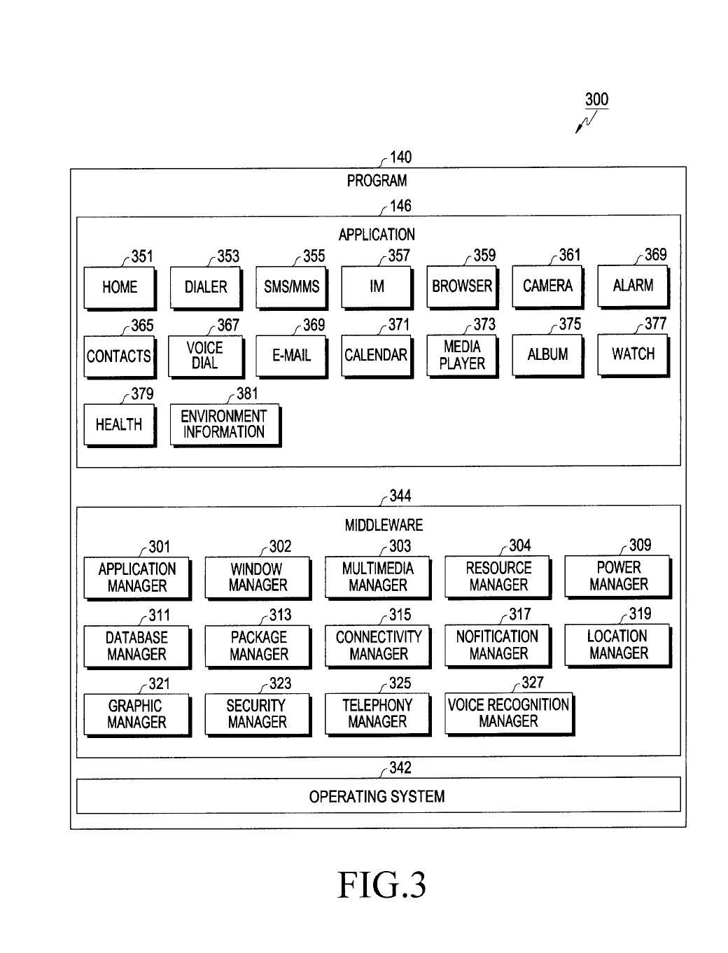

FIG. 3 is a block diagram 300 illustrating a program 140 according to an embodiment. According to an embodiment, the program 140 may include an operating system (OS) 142 to control one or more resources of the electronic device 101, middleware 144, or an application 146 executable on the OS 142. The OS 142 may include, for example, Android™, iOS™, Windows™, Symbian™, Tizen™, or Bada™. At least part of the program 140 may be pre-loaded on the electronic device 101, e.g., upon manufacture, or may be downloaded or updated by an external electronic device (e.g., the electronic device 102 or 104 or the server 108) in a user's use environment.

The OS 142 may control (e.g., allocate or recover) system resources (e.g., the processor, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 so that the application 146 may use functions or information provided from one or more resources of the electronic device 101. The middleware 144 may include, for example, an application manager 301, a window manager 303, a multimedia manager 305, a resource manager 307, a power manager 309, a database manager 311, a package manager 313, a connectivity manager 315, a notification manager 317, a location manager 319, a graphic manager 321, a security manager 323, a telephony manager 325, or a voice recognition manager 327. The application manager 301 may manage the life cycle of, e.g., the applications 146. The window manager 303 may manage, e.g., GUI resources used on the screen. The multimedia manager 305 may grasp, e.g., formats necessary to play media files and use a codec appropriate for a format to perform encoding or decoding on media files. The resource manager 307 may manage, e.g., the source code or memory space of the application 146. The power manager 309 may manage, e.g., the capacity, temperature, or power of the battery and determine and provide power information necessary for the operation of the electronic device 101 using a corresponding piece of information of such. According to an embodiment of the disclosure, the power manager 309 may interwork with a basic input/output system (BIOS).

The database manager 311 may generate, search, or vary a database to be used in the applications 146. The package manager 313 may manage, e.g., installation or update of an application that is distributed in the form of a package file. The connectivity manager 315 may manage, e.g., wireless or wired connection between the electronic device 101 and an external electronic device. The notification manager 317 may provide, e.g., a function for notifying a user of an event (e.g., a call, message, or alert) that occurs. The location manager 319, for example, may manage locational information on the electronic device 101. The graphic manager 321 may manage graphic effects to be offered to the user and their related user interface. The security manager 323 may provide system security or user authentication, for example. The telephony manager 325 may manage, e.g., a voice call or video call function of the electronic device 101. The voice recognition manager 327 may transmit, e.g., a user's voice data to the server 108 and receive a command corresponding to a function to be executed on the electronic device 101 based on the voice data or text data converted based on the voice data. According to an embodiment, the middleware 344 may dynamically delete some existing components or add new components. According to an embodiment, at least part of the middleware 144 may be included as part of the OS 142 or may be implemented in separate software from the OS 142.

The application 146 may include, e.g., an application, such as a home 351, a dialer 353, an SMS/MMS 355, an instant message (IM) 357, a browser 359, a camera 361, an alarm 363, a contact 365, a voice recognition 367, an email 369, a calendar 371, a media player 373, an album 375, or a clock 377, a health 379 (e.g., measuring the degree of workout or blood sugar), or environmental information 381 (e.g., air pressure, moisture, or temperature information). According to an embodiment, the application 146 may further include an information exchanging application (not shown) that is capable of supporting information exchange between the electronic device 101 and the external electronic device. The information exchange application may include, e.g., a notification relay application for transferring designated information (e.g., a call, message, or alert) to the external electronic device or a device management application for managing the external electronic device. The notification relay application may transfer notification information corresponding to an event (e.g., receipt of an email) that occurs at another application (e.g., the email application 369) of the electronic device 101 to the external electronic device, or the notification relay application may receive notification information from the external electronic device and provide the notification information to a user of the electronic device 101. The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application running on the external electronic device.

The electronic device according to various embodiments may be one of various types of electronic devices. The electronic devices may include at least one of, e.g., a portable communication device (e.g., a smartphone), a computer device, a portable multimedia device, a portable medical device, a camera, a wearable device, or a home appliance. According to an embodiment of the disclosure, the electronic device is not limited to the above-listed embodiments.

It should be appreciated that various embodiments of the disclosure and the terms used therein are not intended to limit the techniques set forth herein to particular embodiments and that various changes, equivalents, and/or replacements therefor also fall within the scope of the disclosure. It is to be understood that singular forms such as “a,” “an,” and “the” may also refer to the plural unless the context clearly dictates otherwise. As used herein, the term “A or B,” “at least one of A and/or B,” “A, B, or C,” or “at least one of A, B, and/or C” may include all possible combinations of the enumerated items. As used herein, the terms “1st” or “first” and “2nd” or “second” may refer to corresponding components without implying an order of importance, and are used merely to distinguish each component from the others without unduly limiting the components. It will be understood that when an element (e.g., a first element) is referred to as being (operatively or communicatively) “coupled with/to,” or “connected with/to” another element (e.g., a second element), it can be coupled or connected with/to the other element directly or via a third element.

As used herein, the term “module” includes a unit configured in hardware, software, or firmware and may interchangeably be used with certain other terms, e.g., “logic,” “logic block,” “part,” or “circuit.” A module may be a single integrated component or a portion of a component for performing one or more functions. For example, the module may be configured in an application-specific integrated circuit (ASIC).

Various embodiments as set forth herein may be implemented as software (e.g., the program 140) containing one or more instructions that are stored in a machine (e.g., computer)-readable storage medium (e.g., an internal memory 136) or an external memory 138. The machine may be a device that may invoke the one or more instructions stored in the storage medium and may be operated as per the invoked instruction. The machine may include an electronic device (e.g., the electronic device 101) according to embodiments disclosed herein. When the one or more instructions are executed by a processor (e.g., the processor 120), the processor may perform a function corresponding to the instruction on its own or using other components under the control of the processor. The one or more instructions may contain code that is made by a compiler or code executable by an interpreter. The machine-readable storage medium may be provided in the form of a non-transitory storage medium. Here, the term “non-transitory” simply means that the storage medium does not include transitory signals and is tangible, but this term does not differentiate between where data is permanently or semi-permanently stored in the storage medium and where data is temporarily stored in the storage medium.

According to an embodiment, methods according to various embodiments of the disclosure may be included and provided in a computer program product. The computer program products may be traded as commodities between sellers and buyers. The computer program product may be distributed in the form of a machine-readable storage medium (e.g., a compact disc read only memory (CD-ROM)) or online through an application store (e.g., Playstore™). When distributed online, at least part of the computer program product may be temporarily generated or at least temporarily stored in a storage medium, such as the manufacturer's server, a server of the application store, or a relay server.

According to various embodiments, each component (e.g., module or program) may be implemented as single or multiple components, and the various embodiments disclosed herein may exclude some of the sub components or add other sub components. Alternatively or additionally, some components (e.g., modules or programs) may be integrated into a single entity that may then perform the respective (pre-integration) functions of the components in the same or similar manner. According to various embodiments, operations performed by modules, programs, or other components may be carried out sequentially, in parallel, repeatedly, or heuristically, or at least some operations may be executed in a different order or omitted, or other operations may be added.

According to an embodiment, an electronic device may comprise a housing, a touchscreen display exposed through a portion of the housing, a processor electrically connected to the touchscreen display, and a memory electrically connected with the processor, wherein the memory may store instructions to, when the electronic device is operated, enable the processor to display a user interface including text having a plurality of words, detect a first position of an external object on or adjacent the touchscreen display, determine a single word at least partially based on the first position, provide a translation of the single word in a first mode, detect a second position of the external object on or adjacent the touchscreen display, determine two or more words at least partially based on the second position, and provide a translation of the two or more words in a second mode.

According to an embodiment, the plurality of words may form at least one phrase or sentence. The memory may further store instructions to, when the electronic device is operated, enable the processor to determine the at least one phrase or sentence at least partially based on the second position and provide a translation of the determined phrase or sentence in the user interface in the second mode.

According to an embodiment, the user interface may further include a virtual button configured to switch between the first mode and the second mode.

According to an embodiment, the memory may further store a threshold for, e.g., a duration of a touch input to enable the electronic device to differentiate between a first user input setting the electronic device to the first mode and a second user input setting the electronic device to the second mode, a strength of the touch input, or a distance within which a hovering input is detected.

According to an embodiment, the external object may include a stylus pen.

According to an embodiment, the housing may include a structure configured to receive the stylus pen.

According to an embodiment, the memory may further store instructions to, when the electronic device is operated, enable the processor to, after detecting the external object contacting the touchscreen display, display a menu near a word in the text, and after detecting the external object approaching the touchscreen display without contacting the touchscreen display, display the translation of the single word in the first mode or display the translation of the two or more words in the second mode.

According to an embodiment, the menu may include at least one of a select all item, a copy item, a paste item, or a share item.

According to an embodiment, the memory may further store instructions to, when the electronic device is operated, enable the processor to display a pop-up window including the translation of the single word or the translation of the two or more words near the determined single word or the determined two or more words.

According to an embodiment, the memory may further store instructions to, when the electronic device is operated, enable the processor to identify a position on the touchscreen display corresponding to the first position, determine the single word or the two or more words included in the text based on a type of text displayed in the identified position on the touchscreen display, generate an image corresponding to the determined single word or two or more words and then extract first text from the generated image using an optical character recognition (OCR) scheme, and provide a translation of the extracted first text.

According to an embodiment, the memory may further store instructions to, when the electronic device is operated, enable the processor to, when the type of the text is a text type, extract second text related to the text from an application configured to display the text at the identified position, obtain third text corresponding to the first text from the second text, and obtain fourth text in which an error of the first text is corrected based on the third text.

According to an embodiment, the memory may further store instructions to, when the electronic device is operated, enable the processor to, when the fourth text includes a currency unit, provide a translation of the currency unit based on a currency unit of a country corresponding to a target language for the translation of the single word or the two or more words and, when the fourth text includes a measuring unit, provide a translation of the measuring unit based on a measuring unit of the country corresponding to the target language for the translation of the single word or the two or more words.

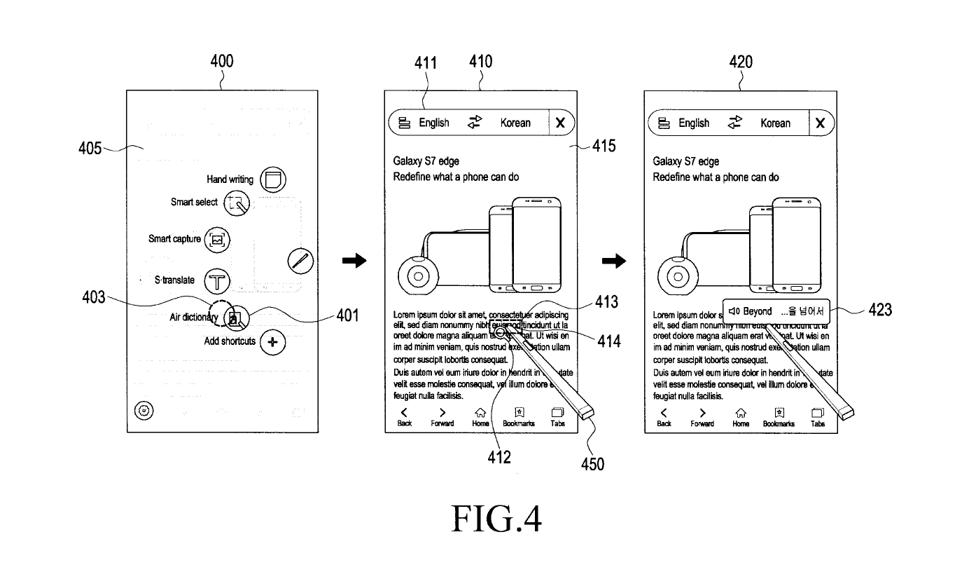

FIG. 4 is a view illustrating a method for selecting a single word the selected word using an electronic device according to an embodiment.

The processor 120 of the electronic device 101, which in turn includes the display device 160, may perform the method.

According to an embodiment, the electronic device 101 may identify the position of an input to the display 210. The input to the display 210 may include a hovering or touch input by at least a portion of the user's body or an external electronic device 450 (e.g., an input device, such as a stylus pen). For example, upon detecting a hovering input by the external electronic device 450, the electronic device 101 may identify the position on the display 210 where the hovering input is detected. In this case, the identified position may be represented with at least one coordinate. The electronic device 101 may display a graphic user interface (GUI), e.g., a cursor, at the identified position on the display 210 to visually represent the detected hovering input.

The electronic device 101 may display a screen 400 in response to a request received from the user or the external electronic device 450. The screen 400 may include at least one or more virtual buttons 401 and a translucent window 405. According to an embodiment, the electronic device 101 may display the screen 400 in response to receiving at least one or more signals from the external electronic device 450. Upon receiving an input 403 (e.g., a hovering or touch input) to the virtual button 401 in the screen 400, the electronic device 101 may run a program, e.g., a translation application, associated with the virtual button 401. At this time, the screen 400 may be removed from the display, which corresponds to the running of the program associated with the virtual button 401.

According to an embodiment, the electronic device 101 may display, on the display 210, an execution screen of at least one application that is running on the electronic device 101. For example, the electronic device 101 may display an execution screen 415 of a browser application on the display 210 in response to a request for running the browser application. The execution screen 415 of the browser application may include images or text (e.g., words, phrases, or sentences). In response to a request for running a translation application, the electronic device 101 may display, on the display 210, a user interface of the translation application that includes a menu 411 and a cursor 412 for selecting the text to be translated.

It can be shown from the screen 410 and the screen 420 that the user interface of the translation application along with the execution screen 415 of the browser application is displayed. The electronic device 101 may display and select a source language (e.g., English) and a target language (e.g., Korean) in the menu 411 and may indicate target text for translation with the cursor 412. The target text may be indicated by the user by adding emphasis to the selected text (e.g., by underlining or by displaying in bold), by changing the color of the text, by indicating the text with a cursor (e.g., arrow or magnifier-shaped cursor), etc.

According to an embodiment, when the web browser application and the translation application are running, the electronic device 101 may identify the position of an input to the display 210 and determine that the text displayed in the identified position is the translation target. For example, where the external electronic device 450 approaches or touches the display 210 of the electronic device 101 as shown in the screen 410, the electronic device 101 may detect the position of the external electronic device 50 using a touch sensor. The electronic device 101 may identify the position 414, on the display 210, corresponding to the detected position of the external electronic device 450. For example, the electronic device 101 may determine a position where at least one or more signals output from the transceiver of the external electronic device 450 is detected. A position on the display 210 corresponding to the position of these signals may be the identified position 414.

According to an embodiment, the electronic device 101 may determine that at least one piece of text displayed at the identified position 414 on the display 210. This piece of text may be further identified as the translation target. For example, the electronic device 101 may determine a single word 413 as the at least one piece of text displayed in the identified position 414 on the display 210. The electronic device 101 may translate the determined word 413 and may output the result of the translation in various forms. For example, the electronic device 101 may display the result of the translation in a pop-up window on the display 210 or output the result as a sound (e.g. spoken word) through the sound output device 155. As shown in the screen 420, the electronic device 101 may display the result of the translation of the determined word 413 in a pop-up window 423 near the determined word 413.

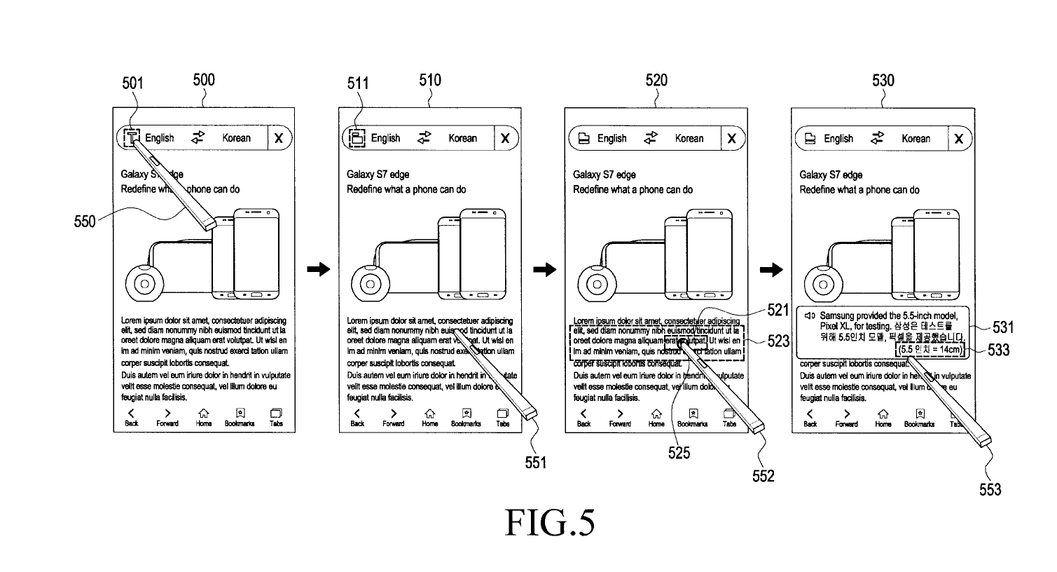

FIG. 5 is a view illustrating a method in which an electronic device executes a single word translation mode or a sentence translation mode for two or more words, according to an embodiment.

The processor 120 of the electronic device 101, which in turn includes the display device 160, may perform the method.

According to an embodiment, the electronic device 101 may select between word translation mode and sentence translation mode in response to a request received from the user. The electronic device 101 may display, on the display 210, a user interface of a translation application in response to a request for executing the translation application. The user interface of the translation application may include a virtual button for selecting the word translation mode or the sentence translation mode. For example, the user interface of the translation application may include a virtual button 501 indicating the word translation mode as shown in the screen 500 or a virtual button 511 indicating the sentence translation mode as shown in the screen 510. The virtual button 501 indicating the word translation mode and the virtual button 511 indicating the sentence translation mode may be displayed in the same position and may switch therebetween, depending on the user input. For example, upon receiving the user input to the virtual button 501 indicating the word translation mode as shown in the screen 500, the electronic device 101 may switch the word translation mode to the sentence translation mode. As the electronic device 101 switches to the sentence translation mode, the virtual button 511 indicating the sentence translation mode may be activated as shown in the screen 510. Likewise, upon receiving the user input to the virtual button 511 indicating the sentence translation mode, the electronic device 101 may switch the sentence translation mode to the word translation mode.

According to an embodiment, the electronic device 101 may switch the default mode for translation between the word translation mode and the sentence translation mode, depending on the settings of the electronic device 101 or the position of the electronic device 101. For example, in one scenario, the default mode for the electronic device 101 may be set to the word translation mode. However, upon determining that the default language for the electronic device 101 changes to a particular language, or the electronic device 101 is located in a particular country, the electronic device 101 may switch the default mode to the sentence translation mode. In another example, where the default language for the electronic device 101 is set to a language that lacks inter-sentence spacing so that the translation of sentences may be more meaningful than the translation of individual words, such as Japanese or Chinese, the electronic device 101 may set the sentence translation mode as the default mode. In other words, although the default mode for the electronic device 101 may be typically set to the word translation mode, if the default language for the electronic device 101 is set to Chinese or Japanese, the electronic device 101 may then switch the default mode to the sentence translation mode. Further, the electronic device 101 may select one of the word translation mode and the sentence translation mode as the default mode based on the position of the electronic device 101. For example, where the position of the electronic device 101 is determined to be in China or Japan, the electronic device 101 may select the sentence translation mode as the default mode.

According to an embodiment, the electronic device 101 may switch between the word translation mode and the sentence translation mode based on the type of input received in a particular position on the display 210. According to an embodiment, the electronic device 101 may perform word translation as per the word translation mode until input is received at the particular position on the display 210. When the input lasts beyond a designated time, and the electronic device 101 may switch the word translation mode to the sentence translation mode to perform sentence translation. For example, the electronic device 101 may identify the position of an input received from the user and may determine the text displayed in the identified position as the translation target. At this time, the electronic device 101 may first translate the word at the identified position as per the word translation mode. When the duration of the input exceeds a designated time, the electronic device 101 may switch from the word translation mode to the sentence translation mode and may translate the whole sentence that includes the word at the identified position.

According to an embodiment, the electronic device 101 may perform word translation corresponding to a first input received at a particular position on the display 210 and sentence translation corresponding to a second input received at the particular position. For example, upon detecting a hovering input that does not contact the display 210 at a particular position on the display 210, the electronic device 101 may perform word translation, and upon detecting a touch input that contacts the display 210 at the particular position on the display 210, the electronic device 101 may perform sentence translation. Alternatively, where the distance within which the hovering input is detected is a first distance or more, the electronic device 101 may perceive it as the first input for performing word translation. But where the distance is less than the first distance, the electronic device 101 may perceive the same as the second input for performing sentence translation. In another embodiment, where the strength of a touch input is less than a predesignated threshold, the electronic device 101 may perceive it as the first input for performing word translation. But where the strength of the touch input exceeds the threshold, the electronic device 101 may perceive the same as the second input for performing sentence translation. As such, the electronic device 101 may perform translation in the word translation mode or sentence translation mode as per the first input and the second input that are received in the particular position on the display 210 and that are distinguished from each other.

According to an embodiment, where the external electronic device 552 approaches or touches the display 210 of the electronic device 101 as shown in the screen 520, the electronic device 101 may detect the position of the external electronic device 552 using a touch sensor. The electronic device 101 may identify the position 525, on the display 210, corresponding to the position of the external electronic device 552. The electronic device 101 may determine at least one word 521 or sentence (or paragraph or two or more words) 523 displayed at the identified position 525 on the display 210 as the translation target. According to an embodiment, the electronic device 101 may provide translation for the word 521 in the word translation mode and translation for the determined sentence 523 in the sentence translation mode.

The electronic device 101 may select the word translation mode or the sentence translation mode based on the duration or type of the input received in the identified position 525 from the external electronic device 552. For example, where the duration of the input received in the identified position 525 from the external electronic device 552 is less than a predesignated threshold, the electronic device 101 may select the word translation mode and translate at least one word 521. Where the duration of the input exceeds the threshold, the electronic device 101 may select the sentence translation mode and translate the sentence 523.

Where the input received in the identified position 525 from the external electronic device 552 is a hovering input, the electronic device 101 may select the word translation mode and translate at least one word 521. Where the input received in the identified position 525 from the external electronic device 552 is a touch input, the electronic device 101 may select the sentence translation mode and translate the sentence 523.

According to an embodiment, the electronic device 101 may display, on the display 210, the result of the translation as shown in the screen 530. For example, the electronic device 101 may determine at least one word 521 or the sentence 523 as the translation target at least partially based on the position where the external electronic device 553 is detected, translate the determined at least one word 521 or sentence 523, and display the result of the translation in a pop-up window 531. Here, displaying the pop-up window is merely one embodiment of displaying the result of the translation. The electronic device 101 may output the result of the translation in other various forms.

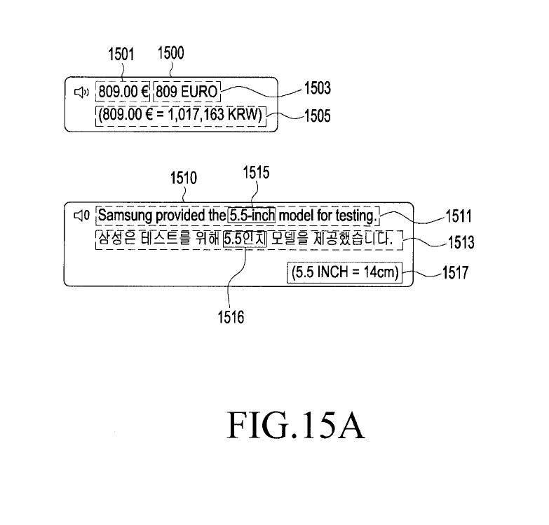

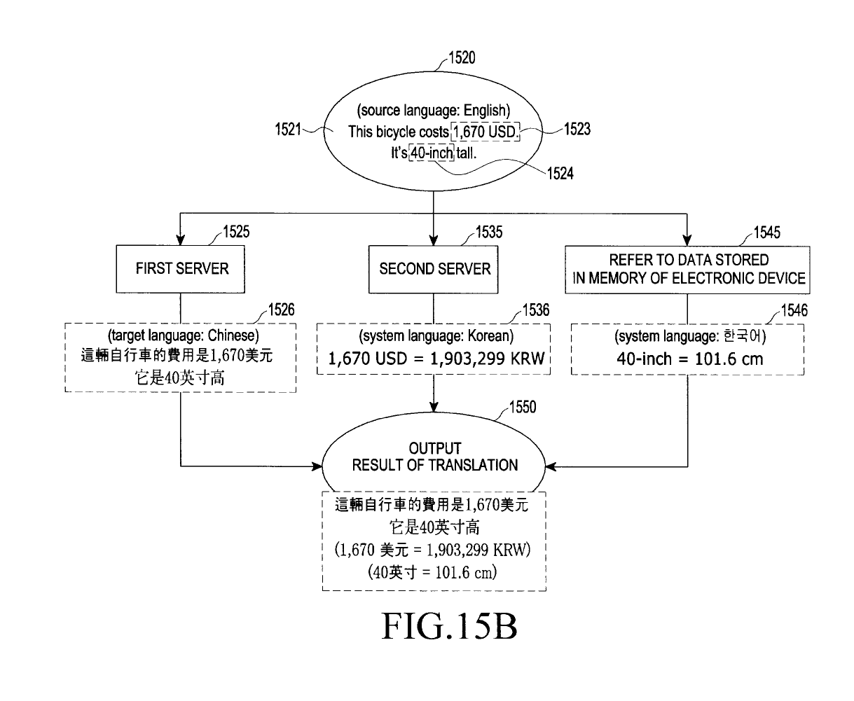

According to an embodiment, upon detecting a hovering input by an external electronic device to at least one piece of text displayed on the display 210, the electronic device 101 may translate the at least one piece of text. Upon detecting a drag input to the display 210, the electronic device 101 may scroll and display the screen on the display 210, corresponding to the detected drag input. Upon detecting a long-press input (e.g., a touch input lasting a preset time period or more) to the display 210, the electronic device 101 may display a menu including various items such as “select all,” “copy,” “paste,” and “share,” etc. Meanwhile, when the at least one word 521 or sentence 523 includes a currency unit (e.g., KRW, USD, EUR, CNY, [symbol] , $, €, or [symbol] ) or measuring unit (e.g., cm, kg, mile, ft, or inch), the electronic device 101 may translate the currency unit or measuring unit in consideration of the default language for the electronic device 101 and/or the target language of the translation. The result 533 of the translation additionally performed on the currency unit or measuring unit may be added to the pop-up window 531. Embodiments of additionally performing currency unit or measuring unit translation are described below in detail with reference to FIGS. 15A and 15B.

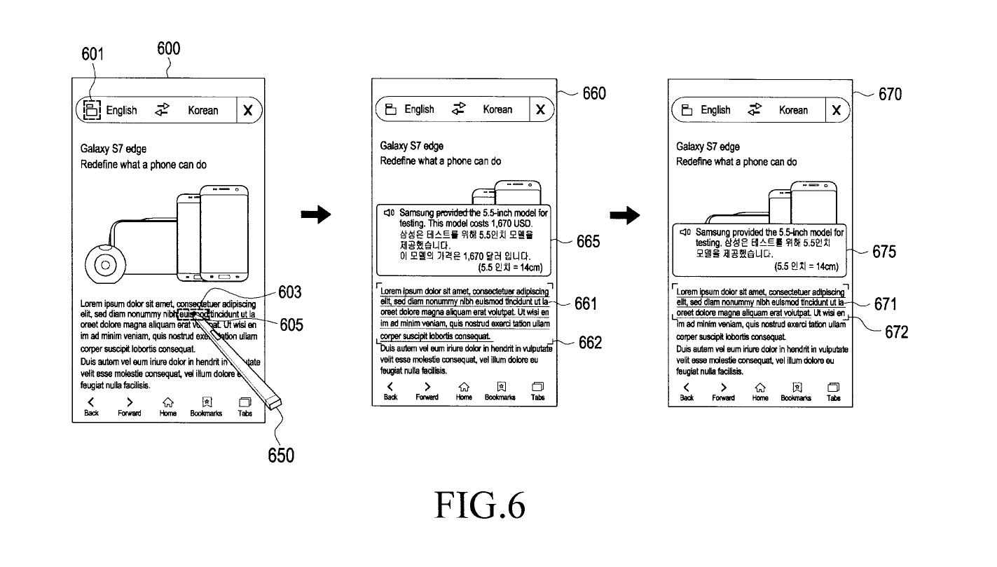

FIG. 6 is a view illustrating a method in which an electronic device selects a sentence or paragraph as a translation target according to an embodiment.

The processor 120 of the electronic device 101, which in turn includes the display device 160, may perform the method.

According to an embodiment, where the external electronic device 650 approaches or touches the display 210 of the electronic device 101 as shown in the screen 600, the electronic device 101 may detect the position of the external electronic device 650 using a touch sensor. Based on the position of the external electronic device 650, the electronic device 101 may then identify the position 605 on the display 210 corresponding to the position of the external electronic device 650. The electronic device 101 may determine that at least one piece of text 603 displayed in the identified position 605 on the display 210 is the translation target. Meanwhile, it can be seen from the virtual button 601 in the screen 600 that the electronic device 101 has been set to the sentence translation mode.

According to an embodiment, where the electronic device 101 is set to the sentence translation mode, the electronic device 101 may automatically determine a sentence or paragraph as the translation target. For example, the electronic device 101 may determine that the sentence including the at least one piece of text (e.g., the word 603) displayed in the identified position 605 is the translation target. In this case, the electronic device 101 may identify the start and end of the sentence based on a period (.), a semicolon (;), or a space.

According to an embodiment, when at least one piece of text displayed in the identified position 605 on the display 210 is determined as the translation target, the electronic device 101 may display a graphic user interface (GUI) 662 that may be used to allow the user to modify the range of the translation target and may change and display the range 661 of the translation target according to the movement of the interface 662. Accordingly, the electronic device 101 may determine text included in the changed range 661 as the translation target. The electronic device 101 may display a pop-up window 665 that includes the result of the translation of the text determined as the translation target. Where the GUI 662 of the screen 660 switches to the GUI 672 of the screen 670, the electronic device 101 may display the range 671 of the translation target after the GUI switch, and may newly determine text in the changed range 671 as the translation target. The electronic device 101 may translate the newly determined text and may display the result of the translation in a pop-up window 675.

Various embodiments of the disclosure are not limited to those described above, and the virtual buttons and GUIs shown in FIG. 6 may be configured in other various forms.

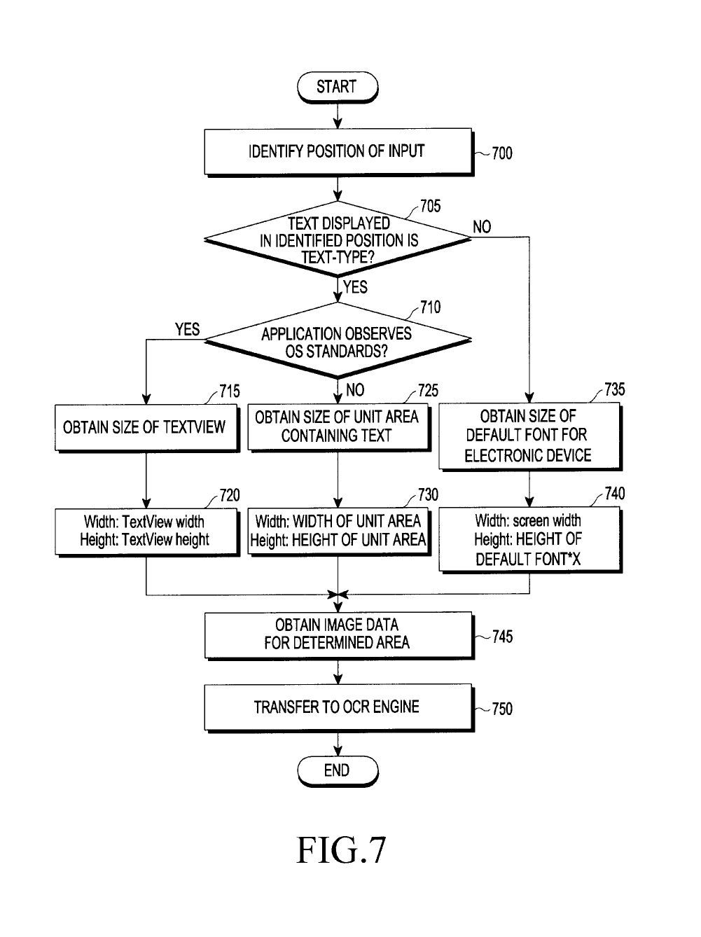

FIGS. 7 to 10 illustrates a method for recognizing text using an OCR scheme according to an embodiment.

FIG. 7 is a flowchart illustrating a method for imaging text using an OCR scheme, according to an embodiment.

The processor 120 of the electronic device 101, which in turn includes the display device 160, may perform the method.

Conventionally, using an OCR scheme to recognize text to be translated may require the capture of the entire screen displayed on the display 210 of the electronic device 101. FIG. 7 illustrates a method for determining an area to be cropped that contains text for recognition using OCR.

According to an embodiment, the electronic device 101 may identify the position of an input to the display 210 in operation 700. For example, where the external electronic device 102 approaches or touches the display 210 of the electronic device 101, the electronic device 101 may detect the position of the external electronic device 102 using a touch sensor. The electronic device 101 may identify the position on the display 210 corresponding to the position of the external electronic device 102.

In operation 705, the electronic device 101 may determine whether the text displayed in the identified position on the display 210 is of a text type or an image type. Here, the text type may mean text constituted of words, phrases, or sentences. The image type may mean text embedded in a still or moving image such as a photo or a video.

Unless the text displayed in the identified position is of the text type, i.e., where the text is embedded in an image file, the electronic device 101 may perform operation 735.

In operation 735, the electronic device 101 may obtain the size of a default font (or system font) for the electronic device 101. Here, the default font may mean a representative font that is output through the display 210 of the electronic device 101 when the electronic device 101 runs at least one program (e.g., operating system (OS) or various applications). The size of the default font obtained in operation 735 may include information related to the absolute size of the default font or information related to the relative size of the default font, e.g., scale factor information.

In operation 740, the electronic device 101 may determine an area to obtain the translation target text based on the obtained default font size. For example, the electronic device 101 may determine that the cropped area for obtaining the translation target text has width (“Width” in 740) equal to the screen width of the display 210 and has height (“Height” in 740) being X times the height of the default font. Here, X may be a positive integer not less than 1. Text in the cropped area may be input into the OCR engine.

In operation 745, the electronic device 101 may obtain image data for the area determined in operation 740. For example, the electronic device 101 may adjust the position of the determined rectangular area so that the center of the determined rectangle is positioned closest to the position identified in operation 700. The electronic device 101 may capture the whole screen displayed on the display 210 and then crop the screen to the size of the determined rectangle and deliver the cropped area to the OCR engine.

Where the text displayed in the identified position is of the text type, the electronic device 101 may perform operation 710.

In operation 710, the electronic device 101 may determine whether the application displaying the translation target text is a program that observes the standards for the operating system (OS) installed on the electronic device 101. Since applications mostly are driven on top the OS installed on the electronic device, they may follow the standards for the OS and may be produce output as per rules set by the OS. However, some applications, e.g., those capable of self-screen configuration such as browsers or eBook applications, may configure their output regardless of the rules set per OS. And thus, the text displayed at the identified position may not be related to the metadata corresponding to the identified position. Hence, the area to be cropped and delivered to the OCR engine may vary depending on whether the application follows the standards for the OS. In operation 710, thus, the electronic device 101 may determine whether the application observes the standards for the OS.

Where the application is a program that observes the standards for the OS installed on the electronic device 101, the electronic device 101 may perform operation 715.

In operation 715, the electronic device 101 may obtain the size of the area including the text displayed in the identified position from the application. For example, where the OS installed on the electronic device 101 is the Android OS, the electronic device 101 may obtain the size of a text view object (TextView) constituting the text displayed in the identified position.

In operation 720, the electronic device 101 may determine the area to be cropped and delivered to the OCR engine the cropped area. For example, the electronic device 101 may determine that the cropped area is coterminous with the area of the text view object.

In operation 745, the electronic device 101 may obtain image data for the area determined in operation 720. For example, the electronic device 101 may adjust the position of the determined rectangular so that the center of the determined rectangle is positioned closest to the position identified in operation 700. The electronic device 101 may capture the whole screen displayed on the display 210 and then crop the screen to the size of the determined rectangle and deliver the cropped area to the OCR engine. However, when the application displaying the translation target text is a program that does not observe the standards for the OS installed on the electronic device 101, the electronic device 101 may perform operation 725.

In operation 725, the electronic device 101 may obtain the size of the unit area including the text displayed in the identified position from the application. Here, the text-containing unit area may mean the area of a paragraph including the text.

In operation 730, the electronic device 101 may determine the area to be cropped and delivered to the OCR engine based on the obtained size of the unit area. For example, the electronic device 101 may determine that the cropped area is coterminous with the area of the unit area.

In operation 745, the electronic device 101 may obtain image data for the area determined in operation 730. For example, the electronic device 101 may adjust the position of the determined rectangular so that the center of the determined rectangle is positioned closest to the position identified in operation 700. The electronic device 101 may capture the whole screen displayed on the display 210 and then crop the screen to the size of the determined rectangle and deliver the cropped area to the OCR engine.

In operation 750, the electronic device 101 may transfer at least one or more image data obtained in operation 745 to the OCR engine of the electronic device 101. Here, the OCR engine may mean a component that may recognize image-type text by use of an OCR scheme, and this engine may be at least one module included in the processor 120 of the electronic device 101.

Operations 720, 730, and 740 merely represent some embodiments to obtain image data to be delivered to the OCR engine and should not be interpreted as limiting the scope of the disclosure. For example, alternatively, the electronic device 101 may use a polygon of a preset size as the area containing text for translation.

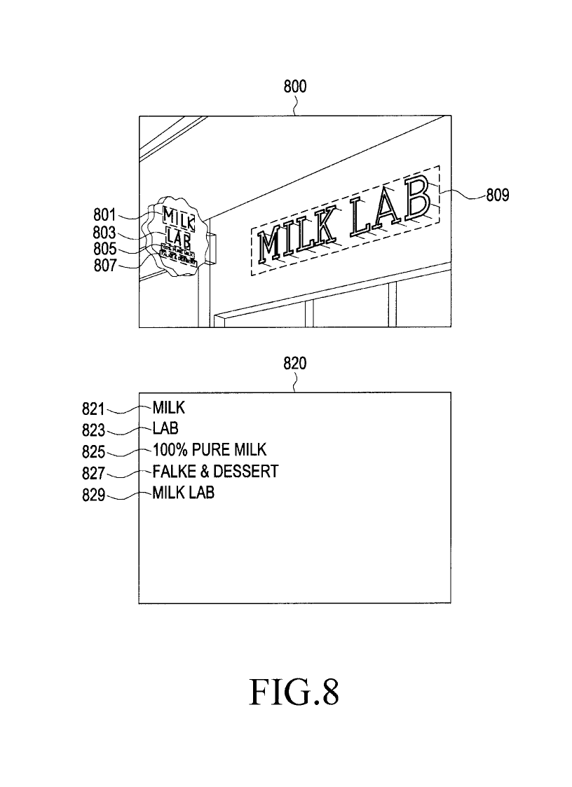

FIG. 8 is a view illustrating a method in which an electronic device recognizes image-type text using an OCR scheme according to an embodiment.

According to an embodiment, the electronic device 101 may recognize at least one piece of text from an image using an OCR scheme. For example, the electronic device 101 may identify various shapes from an image 800 using an OCR scheme and may recognize image-type text from the identified shapes. The electronic device 101 may recognize Milk 821 from image-type text 801, LAB 823 from image-type text 803, 100% PURE MILK 825 from image-type text 805, FLAKE&DESSERT 827 from image-type text 807, and MILK LAB 829 from image-type text 809. The electronic device 101 may extract the recognized pieces of image-type text as shown in the screen 820.

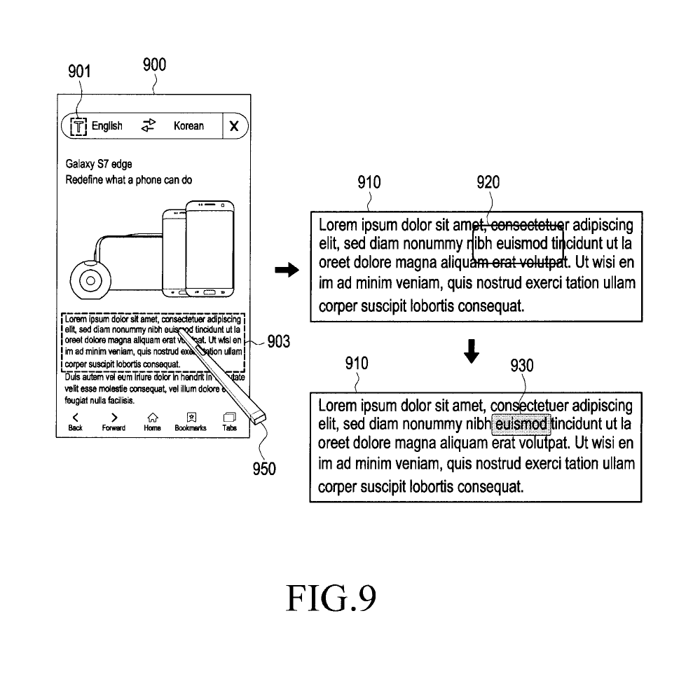

FIG. 9 is a view illustrating a method in which an electronic device recognizes at least one word using an OCR scheme according to an embodiment.

According to an embodiment, the electronic device 101 may identify the position of an input to the display 210. When the external electronic device 950 approaches or touches the display 210 of the electronic device 101 as shown in the screen 900, the electronic device 101 may detect the position of the external electronic device 950 using a touch sensor. The electronic device 101 may identify the position on the display 210 corresponding to the position of the external electronic device 950. The electronic device 101 may determine that at least one piece of text displayed in the identified position on the display 210 is the translation target. Meanwhile, it can be seen from the virtual button 901 in the screen 900 that the electronic device 101 has been set to the word translation mode.

The screen 910 is a magnified version of the portion 903 of the content included in the screen 900, which was set based on the identified position on the display 210. The electronic device 101 may determine the area to obtain the translation target text by determining whether the text is of the text type or image type (e.g., operation 705) or by determining the type of the program displaying the text (e.g., operation 710). In other words, the electronic device 101 may determine the area 920 to obtain the translation target text as per the embodiment described above in connection with FIG. 7.

According to an embodiment, the electronic device 101 may capture the screen 900 as the entire screen displayed on the display 210 and may then crop the determined area 920 off the captured screen 900 and deliver the cropped area to the OCR engine. The electronic device 101 may recognize the image-type text contained in the area 920 via the OCR engine. For example, the electronic device 101 may recognize the text “ibh euismod tinci” from the area 920. Alternatively, the electronic device 101 may identify and leave out meaningless characters from the recognized characters while extracting “euismod” 930 that meaningfully stands as a word. The electronic device 101 may then translate the extracted characters “euismod” 930.

According to an embodiment, the electronic device 101 may provide a user interface (e.g., the GUI 662 of FIG. 6) to allow the user to modify the area 920 used to select the translation target text. In other words, the shape and area of the area 920 may be dynamically varied by the user.

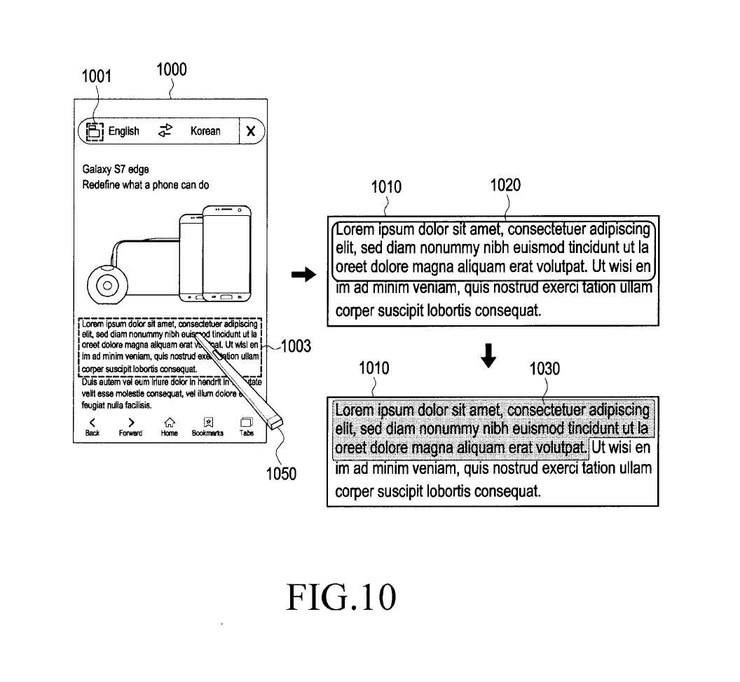

FIG. 10 is a view illustrating a method in which an electronic device recognizes at least one sentence using an OCR scheme according to an embodiment.

According to an embodiment, the electronic device 101 may identify the position of an input to the display 210. When the external electronic device 1050 approaches or touches the display 210 of the electronic device 101 as shown in the screen 1000, the electronic device 101 may detect the position of the external electronic device 1050 using a touch sensor. The electronic device 101 may identify the position on the display 210 corresponding to the position of the external electronic device 1050. The electronic device 101 may determine that at least one piece of text displayed in the identified position on the display 210 is the translation target. Meanwhile, it can be seen from the virtual button 1001 in the screen 1000 that the electronic device 101 has been set to the sentence translation mode.

The screen 1010 is a magnified version of the portion 1003 of the content included in the screen 1000, which was set based on the identified position on the display 210. The electronic device 101 may determine the area to obtain the translation target text by determining whether the text is of the text type or image type (e.g., operation 705) or by determining the type of the program displaying the text (e.g., operation 710). In other words, the electronic device 101 may determine the area 1020 to obtain the translation target text as per the embodiment described above in connection with FIG. 7.

According to an embodiment, the electronic device 101 may capture the screen 1000 as the entire screen displayed on the display 210 and may then crop the determined area 1020 off the captured screen 1000 and deliver the cropped area to the OCR engine. The electronic device 101 may recognize the image-type text contained in the area 1020 via the OCR engine. For example, the electronic device 101 may recognize at least one sentence from the area 1020 based on periods (.), semicolons (;), or spaces. The electronic device 101 may identify and leave out characters that fail to form a sentence from the recognized characters while extracting characters 1030 determined to form a sentence. The electronic device 101 may translate the extracted characters 1030.

According to an embodiment, the electronic device 101 may provide a user interface (e.g., the GUI 662 of FIG. 6) to allow the user to modify the area 1020 used to select the translation target text. In other words, the shape and area of the area 1020 may be dynamically varied by the user.

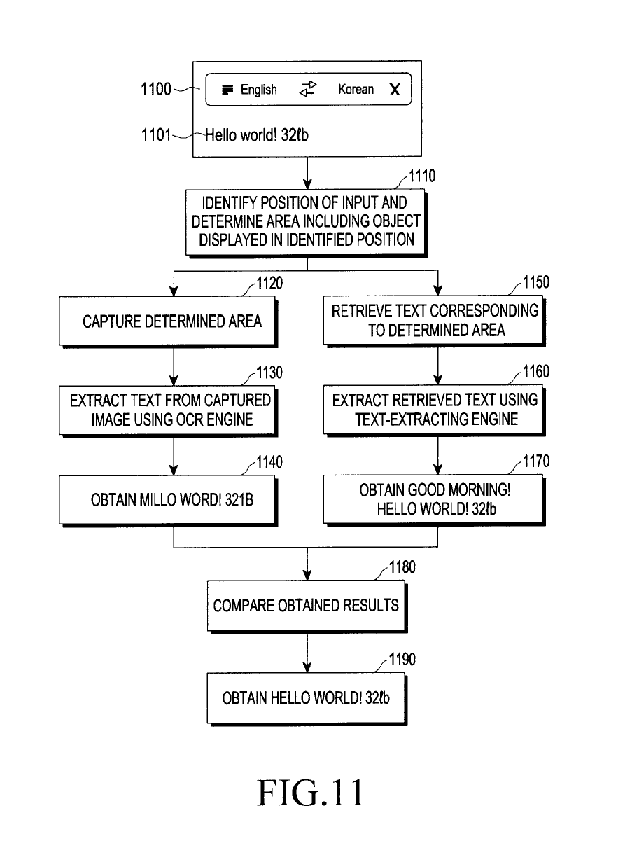

FIG. 11 is a flowchart illustrating a method in which an electronic device recognizes characters using an OCR scheme and a text-extracting scheme and corrects mis-recognized characters, according to an embodiment.

The processor 120 of the electronic device 101, which in turn includes the display device 160 may perform the method.

According to an embodiment, in operation 1110, the electronic device 101 may identify the position of a received input to the display 210 and may determine at least one piece of text displayed at the identified position as a translation target. For example, when “Hello world! 321b” 1101 is the text displayed at the identified position on the display 210, the electronic device 101 may determine “Hello world! 321b” 1101 as the translation target. The screen 1100 shows a user interface of the translation application. The electronic device 101 may specify the translation target by adding emphasis (e.g., highlight) to “Hello world! 321b” 1101.

In operation 1120, the electronic device 101 may capture the whole screen displayed on the display 210 and may then crop an area corresponding to the translation target from the captured whole screen. For example, the electronic device 101 may crop the area containing “Hello world! 321b” 1101.

In operation 1130, the electronic device 101 may extract text from the image of the cropped area using an OCR engine. For example, the electronic device 101 may crop the area containing “Hello world! 321b” 1101 and may then recognize at least one character from the image in the cropped area using the OCR engine. Upon recognizing at least one character, the electronic device 101 may extract the at least one character recognized.

In operation 1140, the electronic device 101 may obtain “millo world! 321b.” Here, “millo world! 321b” may be different from the translation target “Hello world! 321b” 1101. This may be attributed to the nature of the OCR scheme, which is based on the shape of characters. As such, the OCR scheme may not be able to clearly distinguish between similar looking but different characters (e.g., the lowercase “l,” the upper case “I,” and the number “1”). Therefore, the electronic device 101 may mis-recognize “Hello” as “millo” and “32lb” as “321b.” According to an embodiment, to address the mis-recognition issue with the OSR scheme, the electronic device 101 may further adopt a text extracting scheme. Here, the text-extracting scheme may refer to a technique where after identifying the position on the display where the target character is displayed, a program (e.g., an application) set to display at least one character in the identified position directly extracts the relevant text. For example, in Samsung products, the Smart Clip feature may be an example of such text-extracting scheme. Since the text is directly extracted by the program, the extracted text may be regarded as relatively reliable.

According to an embodiment, in operation 1150, the electronic device 101 may retrieve the text corresponding to the cropped area including the translation target. For example, the electronic device 101 may retrieve the text “Hello world! 32lb” 1101 from the application displaying “Hello world! 32lb” 1101. When the text “Hello world! 32lb” 1101 is retrieved from the application displaying “Hello world! 32lb” 1101, the electronic device 101 may perform operation 1160. The text retrieved from the application may be text containing at least part of “Hello world! 32lb” 1101 that is retrieved from the data or metadata (e.g., HTML) constituting the application.

In operation 1160, the electronic device 101 may extract the retrieved text using a text extracting engine. In this case, the extracted text may be related to the identified position and contain at least part of “Hello world! 32lb” 1101.

In operation 1170, the electronic device 101 may obtain “Good morning! Hello world! 32lb.” The text obtained in operations 1150 and 1160 may be related to the identified position and may contain at least part of “Hello world! 32lb” 1101 or may contain text irrelevant to the translation target. Here, for example, “Good morning!” may not be relevant to the translation target. For reference, the reason for extracting irrelevant text is because it may be significantly more time-consuming to retrieve and extract only the text exactly matching “Hello world! 32lb” 1101. Thus, the electronic device 101 may more quickly extract the text containing the translation target by adopting less strict parameters, i.e., extracting text containing the target text as well as other irrelevant text.

In operation 1180, the electronic device 101 may compare the text obtained in operation 1140 with the text extracted in operation 1170. According to an embodiment, in operation 1140, the electronic device 101 may obtain “millo world! 32 lb.” The text obtained in operation 1140 may be less accurate in terms of the content because it has been extracted by the OCR scheme. However, in terms of correspondence to the target text, the text obtained in operation 1140 may be more accurate since it has been extracted from the cropped area corresponding to the translation target. In other words, unlike the text obtained at step 1170, the text obtained at step 1140 likely has no irrelevant text. According to an embodiment, in operation 1170, the electronic device 101 may obtain “Good morning! Hello world! 32lb.” The text obtained in operation 1170 is directly extracted from the application through the text-extracting scheme and may thus be highly accurate in view of content. The text obtained in operation 1170 may be, however, low in accuracy in terms of correspondence to the target text because it may be extracted to include other irrelevant text. Accordingly, the electronic device 101 may determine the content of the target text using the text obtained in operation 1170.

For example, the electronic device 101 may determine that the target text requiring translation is “Hello world! 32lb” based on “millo world! 32lb” obtained in operation 1140 and “Good morning! Hello world! 32lb” obtained in operation 1170.

Thus, the electronic device 101 may obtain “Hello world! 32lb” in operation 1190. Since “Hello world! 32lb” obtained in operation 1190 is the result of extraction obtained by supplementing the OCR scheme with the text-extracting scheme to address the mis-recognition issue with the OCR scheme, it highly likely would match “Hello world! 32lb” 1101 displayed on the screen 1100. The electronic device 101 may translate “Hello world! 32lb” obtained in operation 1190.

According to an embodiment, upon determining “Hello world! 32lb” 1101 displayed on the screen 1100 is the translation target, the electronic device 101 may determine that the paragraph or phrase containing “Hello world! 32lb” 1101 but not displayed on the screen 110 is the translation target. For example, when the phrase “Good morning! Hello world! 32lb. Goodbye!” contains “Hello world! 32lb” 1101 but is not displayed on the screen 1100, and “Hello world! 32lb” 1101 alone is displayed on the screen 1100, the electronic device 101 may determine the entire phrase “Good morning! Hello world! 32lb. Goodbye!” containing “Hello world! 32lb” 1101 as the translation target.

Thus, when a first text is only partially displayed on the display 210 or is not displayed, e.g., when the first text scrolls off the screen, the electronic device 101 may determine whether the first text is necessary for translation based on a second text that is fully displayed on the display 210. Upon determining that the first text and the second text are necessary elements for translation, i.e. they constitute a whole sentence, the electronic device 101, although only the second text is displayed on the display 210, may determine to include the first text in the translation target.

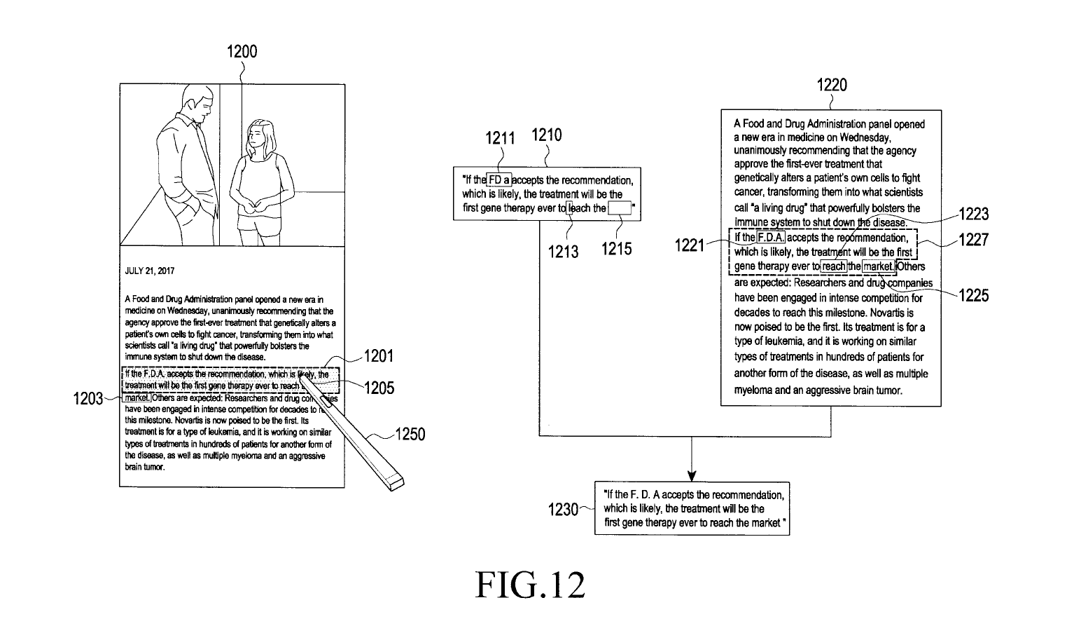

FIG. 12 is a view illustrating a method in which an electronic device recognizes a sentence using an OCR scheme and a text extracting scheme and corrects mis-recognized content in the sentence according to an embodiment.

The processor 120 of the electronic device 101, which in turn includes the display device 160, may perform the method.

According to an embodiment, the electronic device 101 may identify the position of a received input to the display 210 from an external electronic device 1250 and may determine that at least one piece of text displayed at the identified position is the translation target. For example, the electronic device 101 may determine an area 1201 as the translation target based on the position 1205 indicated by the external electronic device 1250. In this case, the electronic device 101 may be in the sentence translation mode.

According to an embodiment, the electronic device 101 may capture the whole screen 1200 displayed on the display 210 and may then crop the area 1201 from the whole screen 1200. The electronic device 101 may then extract text from the area 1201 via an OCR engine. For example, the electronic device 101 may extract the text in the block 1210 from the area 1201, which has been determined as the translation target. Comparison between the area 1201 and the block 1210 may reveal that the two are the same in area but different in content. For example, the electronic device 101 may mis-recognize “F.D.A” in the area 1201 as “FD a” 1211. This may arise from the OCR scheme's failure to identify the period (.), which is represented as a tiny pixel. In addition, the electronic device 101 may mis-recognize “reach” in the area 1201 as “leach” 1213. Further, the text in the block 1210 may not include a period at the end of the sentence, so that the sentence appears incomplete. This may occur when the area 1201 and the block 1210 are missing the last word of the sentence “market.” As set forth above, failure to identify tiny pixel characters, e.g., periods (.), commas (,), or semicolon (;) during the character recognition by the OCR scheme may render it difficult for the electronic device 101 to identify the start and end of the sentence when recognizing sentences via the OCR scheme.

According to an embodiment, to address the mis-recognition issue with the OSR scheme, the electronic device 101 may adopt a text extracting scheme. For example, the electronic device 101 may extract text corresponding to the area 1201 from the application that is displaying the area 1201. For example, the electronic device 101 may extract the text of a block 1220 that includes the area 1201. In comparing the area 1201 and the block 1220, one can see that the area 1201 and the block 1220 contain different ranges of text, but their text may partially overlap. Meanwhile, since the text in the block 1220 contains even tiny pixel characters, e.g., periods (.), the electronic device 101 may precisely identify the start and end of the sentence using the text in the block 1220. For example, the electronic device 101 may identify the missing of part of the sentence, “market” 1203 in the area 1201 using the text in the block 1220. The text in the block 1220 may contain the same “F.D.A” 1221 as “F.D.A” in the area 1201, the same “reach” 1223 as “reach” in the area 1201, and “market” 1225 which has missed from the area 1201.

According to an embodiment, the electronic device 101 may compare the text in the block 1210 with the text in the block 1220. The electronic device 101 may determine the text requiring translation using the text in the block 1210 and may then extract content that matches the text requiring translation in the block 1220. For example, the electronic device 101 may extract the sentence 1227, as the text requiring translation, from the text in the block 1220. Since the sentence 1227 is directly extracted from the application via the text-extracting scheme, the sentence 1227 may be more accurate in content and more complete. Further, since the text in the block 1230 is determined from both the block 1210 and the block 1220, it highly likely would be an accurate extraction of the text in the area 1201. Accordingly, the electronic device 101 may determine the text in the block 1230 as the translation target text and translate the text in the block 1230.

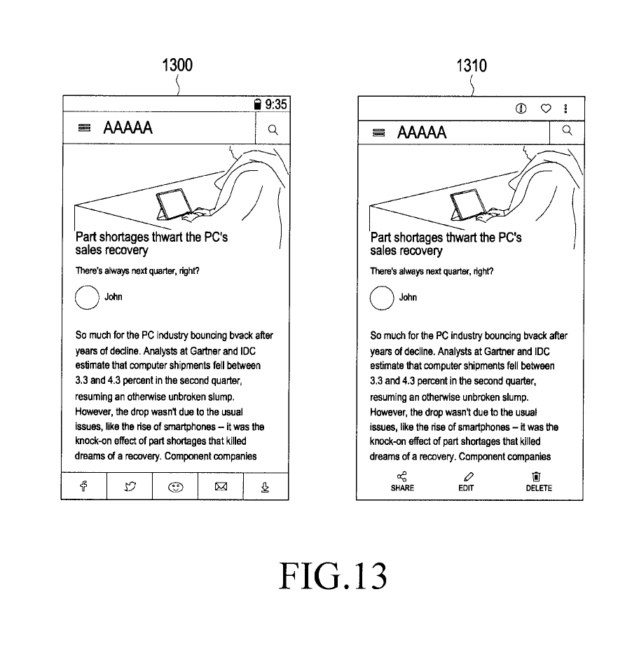

FIG. 13 is a view illustrating an example of comparing when an electronic device extracts text using both an OCR scheme and a text-extracting scheme with when the electronic device extracts text using the OCR scheme alone, according to an embodiment.

According to an embodiment, the electronic device 101 may extract text using both the OCR scheme and the text-extracting scheme. Alternatively, the electronic device 101 may extract text using the OSR scheme only. In this case, extracting text using both the OSR scheme and the text-extracting scheme may present a higher success rate than using the OSR scheme alone.

For example, a screen 1300 represents an execution screen of a program running on the electronic device 101, and a screen 1310 represents a capture of the screen 1300. Since at least one piece of text contained in the screen 1300 is generated by the program running on the electronic device 101, the electronic device 101 may extract at least one piece of text in the screen 1300 from the program running on the electronic device 101. In other words, the electronic device 101 may use the OSR scheme and the text-extracting scheme to extract at least one piece of text in the screen 1300. Conversely, when the screen 1310 consists solely of images, the program running on the electronic device 101 may not be generating the text that is displayed. Accordingly, the electronic device 101 may use the OSR scheme, but not the text-extracting scheme, to extract at least one piece of text in the screen 1310.

Table 1 below shows sentence recognition success rates when recognizing sentences in the screen 1300 using both the OSR scheme and the text-extracting scheme and when recognizing sentences in the screen 1310 using the OSR scheme alone. Sentences 1 to 4 in Table 1 may mean sentences contained in the screen 1300 and the screen 1310.

TABLE 1

| | OCR + text extraction | OCR |
|---|---|---|
| sentence 1 | 0.9 | 0.6 |
| sentence 2 | 0.9 | 0.9 |
| sentence 3 | 0.8 | 0.5 |
| sentence 4 | 0.9 | 0.4 |

As shown in Table 1, recognizing sentences in the screen 1300 using both the OSR scheme and the text-extracting scheme exhibits a sentence recognition success rate of 80% or more for all the sentences. However, recognizing sentences in the screen 1310 using the OSR scheme alone gives a sentence recognition success rate of 40% for some sentences. It can be verified from Table 1 above that extracting text using both the OSR scheme and the text-extracting scheme may present a higher text recognition success rate than using the OSR scheme alone.

The differences in success rate between adopting both the OSR scheme and the text-extracting scheme and adopting only the OSR scheme, as shown in Table 1, may be used to determine whether to use both the OSR scheme and the text-extracting scheme when an electronic device recognizes at least one character displayed on the screen.

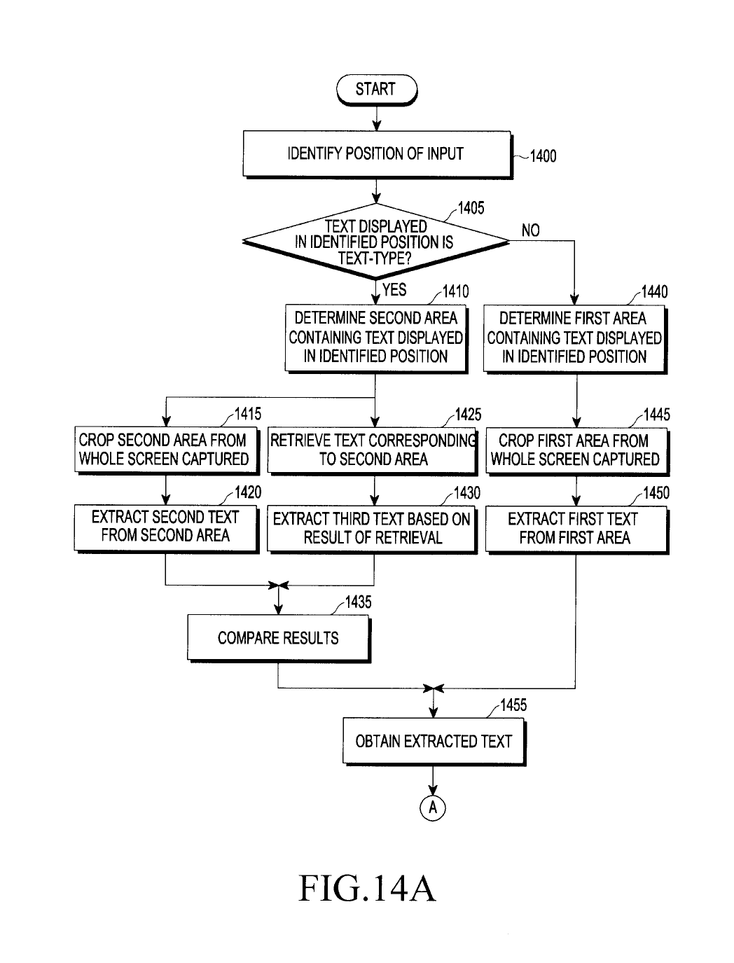

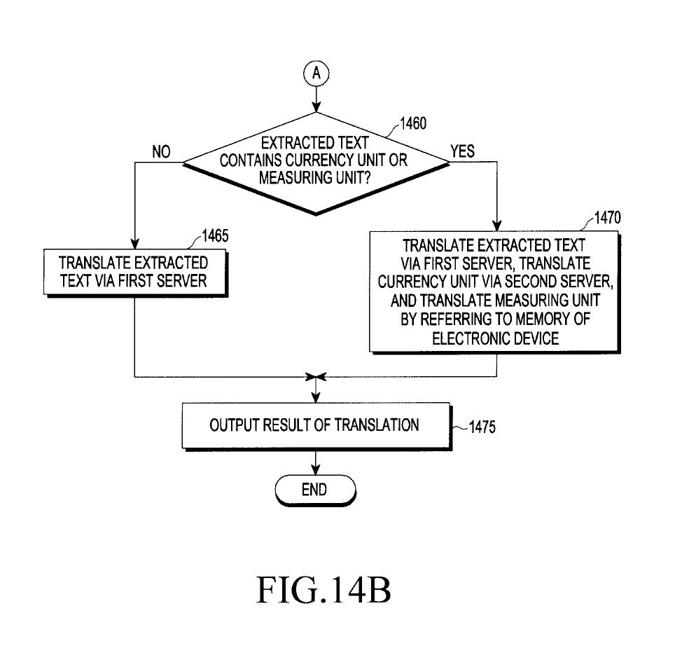

FIGS. 14A and 14B are flowcharts illustrating a method in which an electronic device recognizes at least one character displayed on a display, according to an embodiment.

The processor 120 of the electronic device 101, which in turn includes the display device 160, may perform the method.

According to an embodiment, the electronic device 101 may recognize characters displayed on the display 210 of the electronic device 101 and extract the recognized characters as shown in FIG. 14A.

In operation 1400, the electronic device 101 may identify the position of an input to the display 210. For example, where the external electronic device 102 approaches or touches the display 210 of the electronic device 101, the electronic device 101 may detect the position of the external electronic device 102 using a touch sensor. The electronic device 101 may identify the position on the display 210 corresponding to the position of the external electronic device 102.

In operation 1405, the electronic device 101 may determine whether the text displayed in the identified position on the display 210 is of a text type or an image type. Here, the text type may mean text constituted of words, phrases, or sentences. The image type may mean text embedded in a still or moving image such as a photo or a video.

Unless the text displayed in the identified position is of the text type, the electronic device 101 may perform operations 1440, 1445, 1450, and 1455.

In operation 1440, the electronic device 101 may determine a first area on the display 210 including the text displayed in the identified position. For example, the electronic device 101 may obtain the size of the default font (or system font) for the electronic device 101 and determine the first area based on the obtained size of the default font. The electronic device 101 may determine the first area as a rectangle with the screen width of the display 210 as its width and X times the height of the default font as its height.

In operation 1445, the electronic device 101 may capture the whole screen displayed on the display 210 and may then crop the determined first area from the captured whole screen. In operation 1450, the electronic device 101 may extract first text from the cropped first area.

In operation 1455, the electronic device 101 may obtain the extracted text. As such, in operations 1440-1455, the electronic device 101 may extract text using the OSR scheme. The OCR′ed text can then be translated.

Where the text displayed in the identified position is of the text type, the electronic device 101 may perform operations 1410, 1415, 1420, 1425, 1430, 1435, and 1455.

In operation 1410, the electronic device 101 may determine a second area including the text displayed in the identified position. According to an embodiment, the electronic device 101 may determine the second area as an area including the text at the identified position and obtain the size of the second area from the application displaying the text at the identified position. For example, where the OS installed on the electronic device 101 is the Android OS, the electronic device 101 may obtain the size of a text view (TextView) object that includes the text displayed at the identified position. According to another embodiment, the electronic device 101 may determine that the size of the paragraph containing the text displayed in the identified position is the size of the second area.

In operation 1415, the electronic device 101 may capture the whole screen displayed on the display 210 and may then crop the determined second area from the captured whole screen. In operation 1420, the electronic device 101 may extract second text from the cropped second area.

In operation 1425, the electronic device 101 may retrieve text corresponding to the second area from the application displaying the text. In operation 1430, the electronic device 101 may extract third text based on the result of the retrieval. A text extracting engine may be used to retrieve and extract the text.

In operation 1435, the electronic device 101 may compare the second text extracted in operation 1420 with the third text extracted in operation 1430 and may obtain fourth text based on the result of the comparison in operation 1455. For example, the electronic device 101 may determine the text requiring translation based on the second text extracted via the OSR scheme and determine the content of the translation target text based on the third text extracted via the text-extracting scheme. The electronic device 101 may then obtain the fourth text as a result of the determination.

According to an embodiment, where a particular character is contained in the extracted text as shown in FIG. 14B, the electronic device 101 may separately translate the particular character.

For example, where the extracted text includes a currency unit (e.g., KRW, USD, EUR, CNY, [symbol] , $, [symbol] , or ¥) or measuring unit (e.g., cm, kg, mile, ft, or inch), the electronic device 101 may translate the currency unit or measuring unit while taking into account the default language for the electronic device 101 or the target language of translation. Where the default language for the electronic device 101 or the target language for the translation is set to English, and the extracted text contains a currency unit other than the dollar symbol (USD or $), the electronic device 101, upon translating the extracted text, may convert the other currency symbol contained in the extracted text into the dollar unit and may provide the result of the conversion along with the result of the translation.

To that end, in operation 1460, the electronic device 101 may determine whether the extracted text contains a currency or measuring unit.

Upon determining that the extracted text contains no currency or measuring unit, the electronic device 101 may perform operations 1465 and 1475.

In operation 1465, the electronic device 101 may translate the extracted text via a first server. For example, the electronic device 101 may transmit the translation target (e.g. the extracted text) to the first server and receive the result of the translation from the first server. The first server may mean a typical server that provides language translation services, such as Google Translate™ or Naver Papago™. In operation 1475, the electronic device 101 may output the result of translation received from the first server.

Upon determining that the extracted text contains a currency or measuring unit, the electronic device 101 may perform operations 1470 and 1475.

In operation 1470, the electronic device 101 may translate the extracted text via the first server while simultaneously translating (or converting) the currency unit contained in the extracted text via a second server. The electronic device 101 may also translate the extracted text via the first server while simultaneously translating (or converting) the measuring unit contained in the extracted text by referring to the memory 130 of the electronic device 101. The electronic device 101 may transmit the translation target (e.g. the extracted text) to the first server and receive the result of the translation from the first server. The electronic device 101 may also transmit the currently unit-related data or text to the second server and receive the result of the translation from the second server. The electronic device 101 may translate the measuring unit by using a table stored in the memory 130 and/or by computation of the processor 120. The first server may mean a typical server that provides language translation services as mentioned above, and the second server may mean a server (e.g., OANDA′) that provides currency-exchange computation services. In operation 1475, the electronic device 101 may combine and output the result of the translation received from the first server, the result of the translation received from the second server, and the result of the translation obtained by referring to the memory 130 of the electronic device 101.

FIGS. 15A and 15B are views illustrating a method in which an electronic device translates a currency unit or measuring unit according to an embodiment.

FIG. 15A is a view illustrating a method for performing translation considering the current position of the electronic device or the default language or target language for the electronic device according to an embodiment.

According to an embodiment, the electronic device 101 may recognize at least one character displayed on the display 210 of the electronic device 101 and extract the at least one character recognized as text. In this case, where the extracted text includes a currency unit (e.g., KRW, USD, EUR, CNY, [symbol] , $, [symbol] , or ¥) or measuring unit (e.g., cm, kg, mile, ft, or inch), the electronic device 101 may translate the currency unit or measuring unit taking into account the default language or for the electronic device 101 or the target language of translation or the current position of the electronic device 101.

For example, upon determining that the default language or target language for the electronic device 101 is set to Korean, or the current position of the electronic device 101 is in Korea, the electronic device 101 may use the currency unit or measuring unit commonly used in Korea when translating the text.

According to an embodiment, when there is a request for translating English to Korean, the electronic device 101 may translate “809.00 €” 1501 contained in the screen 1500 into “809 EURO” 1503. Further, the electronic device 101 may convert “809.00€” 1501 to Korean Won (KRW), which is the Korean currency unit, and output the converted result given that the default language or target language for the electronic device 101 is set to Korean or the electronic device 101 is currently in Korea. For example, the electronic device 101 may display “(809.00€=1,017,163 KRW)” 1505 on the screen 1500.

According to an embodiment, when there is a request for translating English into Korean, the electronic device 101 may translate “Samsung provided the 5.5-inch model for testing.” 1511 contained in the screen 1510 into “ [symbol] [symbol] [symbol] 5.5 [symbol] [symbol] .” 1513. The electronic device 101 may translate the measuring unit contained in the text, e.g., “5.5-inch,” 1515 into “5.5 [symbol] ” 1516. Further, the electronic device 101 may convert “5.5-inch” 1515 to centimeters, which is the measuring unit commonly used in Korea, and output the converted result given that the default language or target language for the electronic device 101 is set to Korean or the electronic device 101 is currently in Korea. For example, the electronic device 101 may display “(5.5-inch=14 cm)” 1517 on the screen 1510.

FIG. 15B is a view illustrating a method for translating a sentence containing a currency unit or measuring unit using different servers or different languages, wherein one of the servers or one of the languages is used to translate the sentence and the other server or the other language is used to translate the currency or measuring unit.

According to an embodiment, the sentence may be translated via a first server, the currency unit may be translated via a second server, and the measuring unit may be translated by the electronic device 101.

As shown in FIG. 15B, the electronic device 101 may translate the sentence via the first server 1525. For example, in operation 1520, the electronic device 101 may receive a request related to translating the English sentences “This bicycle costs 1,670 USD. It's 40-inch tall.” 1521 into Chinese. The electronic device 101 may perform translation via the first server 1525 corresponding to the received request. The first server may be a typical server that provides language translation services, such as Google Translate™ or Naver Papago™. The electronic device 101 may obtain the Chinese translation “ [symbol] [symbol] 1, 670 [symbol] [symbol] .” 1526 from the first server 1525.

The electronic device 101 may translate the currency unit contained in the sentence via the second server 1535. For example, where the sentence contains a currency unit, e.g., “1,670 USD” 1523, the electronic device 101 may translate the currency unit via the second server 1535. Here, the second server may mean a server (e.g., OANDA™) that provides currency exchange computation services. The electronic device 101 may obtain a currency conversion of “1,670 USD” 1523 into another currency unit, e.g., “1,903,299 KRW” 1536 from the second server 1535.

In operation 1545, the electronic device 101 may translate the measuring unit contained in the sentence based on at least one piece of information (e.g., a table) stored in the memory 130 of the electronic device 101. For example, where the sentence to be translated contains a measuring unit, e.g., “40-inch” 1524, the electronic device 101 may translate the measuring unit using at least one piece of information stored in the memory 130. The electronic device 101 may obtain a conversion of “40-inch” 1524 into another measuring unit, e.g., “101.6 cm” 1546 based on the information stored in the memory 130.

According to the above embodiment, the sentence may be translated in a first language (e.g. Chinese), and the currency or measuring unit may be translated in a second language (e.g. Korean).

The sentence translation may be carried out based on setting the source language and the target language. Where the source language is set to English, and the target language is set to Chinese, the electronic device 101 may translate English sentences into Chinese. For example, in operation 1520, the electronic device 101 may receive a request for translating the English sentence “This bicycle costs 1,670 USD. It's 40-inch tall.” 1521 into Chinese. Corresponding to the received request, the electronic device 101 may translate “This bicycle costs 1,670 USD. It's 40-inch tall.” 1521 into Chinese. The electronic device 101 may transmit the translation target “This bicycle costs 1,670 USD. It's 40-inch tall.” 1521 to the first server 1525 that provides a language translation service and may obtain the Chinese translation “ [symbol] [symbol] 1, 670 [symbol] 40 [symbol] .” 1526 from the first server 1525.

The translation of the currency or measuring unit may be performed based on the default language for the electronic device 101 or the current position of the electronic device 101. Upon determining that the default language for the electronic device 101 is set to Korean, or the electronic device 101 is currently in Korea, the electronic device 101 may translate the currency or measuring unit contained in the sentence into a Korean currency or measuring unit. For example, in operation 1520, the electronic device 101 may receive a request for translating the English sentence “This bicycle costs 1,670 USD. It's 40-inch tall.” 1521 into Chinese. Corresponding to the received request, the electronic device 101 may identify the currency unit “1,670 USD” 1523 and the measuring unit “40-inch” 1524 contained in “This bicycle costs 1,670 USD. It's 40-inch tall.” 1521. In this case, upon determining that the system language for the electronic device 101 is set to Korean or the electronic device 101 is currently in Korea, the electronic device 101, although the target language for translation is Chinese, may convert “1,670 USD” 1523 and “40-inch” 1524 into currency and measuring units used in Korea. The electronic device 101 may transmit translation target “1,670 USD” 1523 and Korea-related data to the second server 1535 and may obtain the currency conversion “1,903,299 KRW” 151 from the second server 1535. The electronic device 101 may obtain the measuring unit “101.6 cm” 1546 converted from “40-inch” 1524 using at least one piece of information stored in the memory 130.

According to an embodiment, in operation 1550, the electronic device 101 may combine the result of the translation of the sentence performed by the first server 1525, the result of the translation of the currency unit performed by the second server 1535, and the result of the translation of the measuring unit performed by referencing (operation 1545) the data stored in the memory of the electronic device and may output a result of the combination.

According to an embodiment, the electronic device 101 may consider the year or era when the text containing a currency or measuring unit was created when translating the currency or measuring unit. For example, upon determining that the text “This bicycle costs 1,670 USD. It's 40-inch tall.” 1521 was created in the 1970s, the electronic device 101 may translate the currency unit given the currency value of the 1970s. To take the year or era the text was created into account, the electronic device 101 may receive data related to the year or era the text was created from at least one server. The electronic device 101 may translate the currency unit “1,670 USD” 1523 contained in “This bicycle costs 1,670 USD. It's 40-inch tall.” 1521 based on the received data.

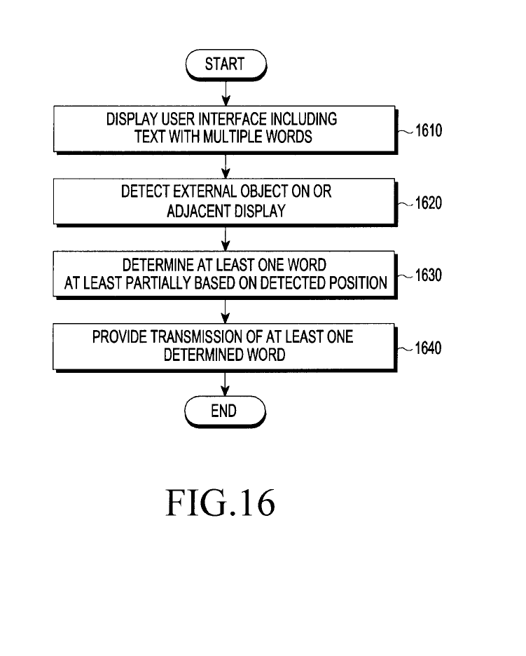

FIG. 16 is a flowchart illustrating a method for translating text displayed on a display of an electronic device 101 according to an embodiment.

The processor 120 of the electronic device 101, which in turn includes the display device 160 may perform the method.

According to an embodiment, in operation 1610, the electronic device 101 may display a user interface including text containing a plurality of words. For example, at least one program (e.g., an application) running on the electronic device 101 may include a user interface containing images and/or text.

In operation 1620, the electronic device 101 may detect the position of an external object over or close to the display 210. For example, where the external object approaches or contacts the display 210 of the electronic device 101, the electronic device 101 may detect the position of the external object using a touch sensor. The electronic device 101 may identify the position on the display 210 corresponding to the position of the external object. Here, the external object may include at least a portion of an external electronic device 102 (e.g., a stylus pen) or the user's body (e.g. a finger).

In operation 1630, the electronic device 101 may determine at least one word at least partially based on the detected position. The electronic device 101 may identify at least one word displayed on the display 210 based on the detected position of the external object and may determine that the at least one word is a translation target. According to an embodiment, where the electronic device 101 is set to the word translation mode, the electronic device 101 may identify a single word based on the detected position. Where the electronic device 101 is set to the sentence translation mode, the electronic device 101 may identify two or more words based on the detected position.

In operation 1640, the electronic device 101 may translate the identified at least one word. To that end, the electronic device 101 may extract text using an OCR engine and/or text-extracting engine. The electronic device 101 may translate the extracted text.

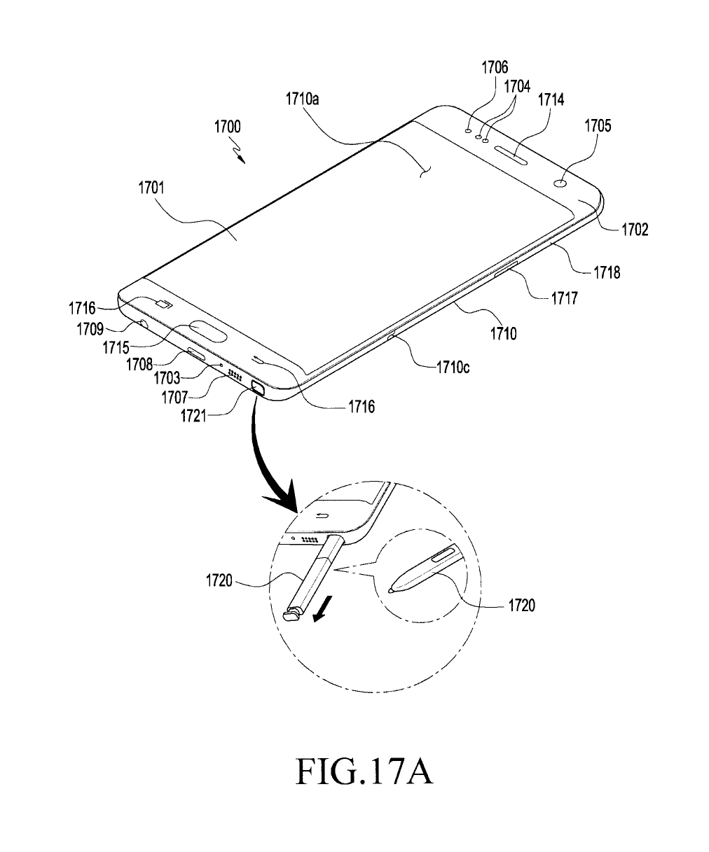

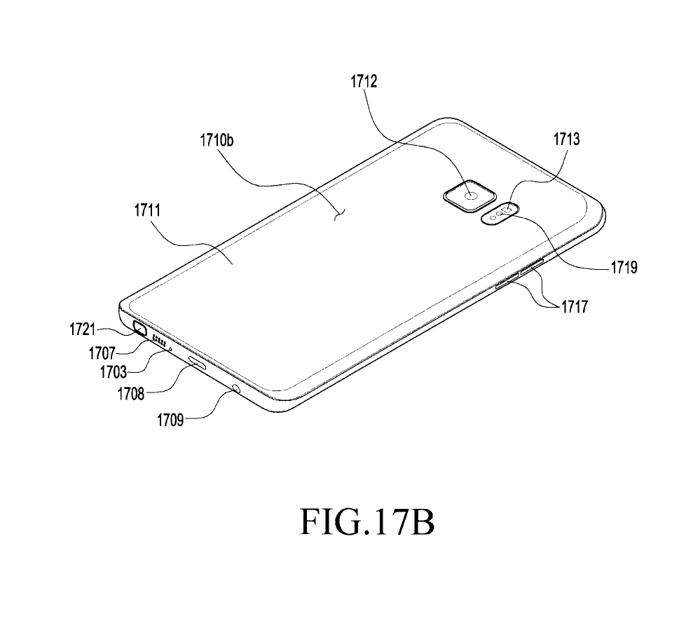

FIGS. 17A and 17B, respectively, are a front perspective view and a rear perspective view illustrating an electronic device 101 according to an embodiment.

Referring to FIGS. 17A and 17B, according to an embodiment, an electronic device 1700 (e.g., the electronic device 101) may include a housing 1710 that has a first (or front) surface 1710a, a second (or rear) surface 1710b, and a side surface 1710c surrounding the space between the first surface 1710a and the second surface 1710b. According to an embodiment (not shown), the housing may include a structure forming part of the first surface 1710a, the second surface 1710b, and the side surface 1710c of FIG. 17A. According to an embodiment, the first surface 1710a may be formed by a front plate 1702 (e.g., a glass plate or polymer plate with various laminated layers) at least part of which is substantially transparent. The second surface 1710b may be formed by a rear plate 1711 that is substantially opaque. The rear plate 1711 may be formed of, e.g., laminated or colored glass, ceramic, polymer, metal (e.g., aluminum, stainless steel (STS), or magnesium), or a combination of at least two thereof. The side surface 1710c may be formed by a side bezel structure (or a “side member”) 1718 that couples to the front plate 1702 and the rear plate 1711 and includes a metal and/or polymer. According to an embodiment, the rear plate 1711 and the side bezel plate 1718 may be integrally formed together and include the same material (e.g., a metal, such as aluminum).

According to an embodiment, the electronic device 1700 may include at least one or more of a display 1701 (e.g., the display 210), audio modules 1703, 1707, and 1714 (e.g., the audio module 170), sensor modules 1704 and 1719 (e.g., the sensor module 176), camera modules 1705, 1712, and 1713 (e.g., the camera module 180), key input devices 1715, 1716, and 1717, an indicator 1706, connector holes 1708 and 1709, and an input unit 1720. According to an embodiment, the electronic device 1700 may exclude at least one (e.g., the key input devices 1715, 1716, and 1717 or the indicator 1706) of the components or may add other components.

The display 1701 may be exposed through the top of, e.g., the front plate 1702. The display 1701 may be disposed to be coupled with, or adjacent, a touch detecting circuit, a pressure sensor capable of measuring the strength (pressure) of touches, and/or a digitizer for detecting the input unit 1720 that is a magnetic type.

The audio modules 1703, 1707, and 1714 may include a microphone hole 1703 and speaker holes 1707 and 1714. The microphone hole 1703 may have a microphone inside to obtain external sounds. According to an embodiment, there may be a plurality of microphones to be able to detect the direction of a sound. The speaker holes 1707 and 1714 may include an external speaker hole 1707 and a phone receiver hole 1714. According to an embodiment, the speaker holes 1707 and 1714 and the microphone hole 1703 may be implemented as a single hole, or speakers may be rested without the speaker holes 1707 and 1714 (e.g., piezo speakers).

The sensor modules 1704 and 1719 may generate an electrical signal or data value corresponding to an internal operating state or external environmental state of the electronic device 1700. The sensor modules 1704 and 1719 may include a first sensor module 1704 (e.g., a proximity sensor) disposed on the first surface 1710a of the housing 1710, and/or a second sensor module (not shown) (e.g., a fingerprint sensor), and/or a third sensor module 1719 (e.g., a heart-rate monitor (HRM) sensor) disposed on the second surface 1710b of the housing 1710. The fingerprint sensor may be disposed on the second surface 1710b as well as on the first surface 1710a (e.g., the home key button 1715) of the housing 1710. The electronic device 1700 may further include sensor modules not shown, e.g., at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor 1704.

The camera modules 1705, 1712, and 1713 may include a first camera device 1705 disposed on the first surface 1710a of the electronic device 1700, and a second camera device 1712 and/or a flash 1713 disposed on the second surface 1710b. The camera modules 1705 and 1712 may include one or more lenses, an image sensor, and/or an image signal processor. The flash 1713 may include, e.g., a light emitting diode (LED) or a xenon lamp. According to an embodiment, two or more lenses (a wide-angle lens and a telescopic lens) and image sensors may be disposed on one surface of the electronic device 1700.

The key input devices 1715, 1716, and 1717 may include a home key button 1715 disposed in the first surface 1710a of the housing 1710, a touchpad 1716 disposed around the home key button 1715, and/or a side key button 1717 disposed on the side surface 1710c of the housing 1710. According to an embodiment, the electronic device 1700 may exclude all or some of the above-mentioned key input devices 1715, 1716, and 1717 and the excluded key input devices 1715, 1716, and 1717 may be implemented in other forms, e.g., as soft keys on the display 1701.

The indicator 1706 may be disposed, e.g., on the first surface 1710a of the housing 1710. The indicator 1706 may provide, e.g., state information about the electronic device 1700 in the form of light and may include an LED.

The connector holes 1708 and 1709 may include a first connector hole 1708 for receiving a connector (e.g., a universal serial bus (USB) connector) for transmitting or receiving power and/or data to/from an external electronic device and/or a second connector hole 1709 (e.g., an earphone jack) for receiving a connector for transmitting or receiving audio signals to/from the external electronic device.

The input unit 1720 (e.g., a stylus pen or electronic pen) may be accommodated in the electronic device 1700 through a recess 1721 provided in a portion of the side surface 1710c of the housing 1710. The input unit 1720 may be removed from the electronic device 1700. The input unit 1720 may touch the display 1701 to deliver the touch input to the electronic device 1700 or may approach the display 1701 to deliver the hovering input to the electronic device 1700. According to an embodiment, the input unit 1720 may be inserted and stored inside the electronic device 1700, and for use, may be removed from the electronic device 1700. In an inner portion of the electronic device 1700 where the input unit 1720 is inserted may be provided an insertion/removal recognition switch (not shown) that is operated corresponding to the insertion or removal of the input unit 1720, and the insertion/removal recognition switch may output signals corresponding to the insertion and removal of the input unit 1720 to the processor 120. The insertion/removal recognition switch may be configured to directly or indirectly contact the input unit 1720 when the input unit 1720 is inserted. The insertion/removal recognition switch may produce a signal corresponding to the insertion or removal of the input unit 1720 (e.g., a signal to indicate the insertion or removal of the input unit 1720) based on whether the switch contacts the input unit 1720 and output the signal to the processor 120. The input unit 1720 may be an input means-equipped device. In this case, the processor 120 of the electronic device 1700 may generate a pointer in any position on the display 1701, which is the display unit, when the input unit 1720 is pulled out or removed. Where the input unit 1720 is positioned on the top of the display 1701, the processor 120 may detect a variation in the position of the input unit 1720 and move the pointer corresponding to the variation in the position.

According to an embodiment, a method for recognizing a character displayed on a touchscreen display of an electronic device may comprise displaying a user interface including text having a plurality of words, detecting a first position of an external object on or adjacent the display, determining a single word at least partially based on the first position, providing a translation of the single word in a first mode, detecting a second position of the external object on or adjacent the display, determining two or more words at least partially based on the second position, and providing a translation of the two or more words in a second mode.

According to an embodiment, the plurality of words may form at least one phrase or sentence. The method may further comprise determining the at least one phrase or sentence at least partially based on the second position and providing a translation of the determined phrase or sentence in the user interface in the second mode.

According to an embodiment, the user interface may further include a virtual button configured to switch between the first mode and the second mode.

According to an embodiment, the electronic device may store, in a memory of the electronic device, a threshold for at least one of a duration of a touch input to enable the electronic device to differentiate between a first user input setting the electronic device to the first mode and a second user input setting the electronic device to the second mode, a strength of the touch input, or a distance within which a hovering input is detected.

According to an embodiment, the external object may include a stylus pen.

According to an embodiment, the housing may include a structure configured to receive the stylus pen.

According to an embodiment, the method may further comprise, after detecting the external object contacting the display, displaying a menu near a word in the text, and after detecting the external object approaching the display without contacting the touchscreen display, displaying the translation of the single word in the first mode or displaying the translation of the two or more words in the second mode.

According to an embodiment, the menu may include at least one of a select all item, a copy item, a paste item, or a share item.

According to an embodiment, the method may further comprise displaying a pop-up window including the translation of the single word or the translation of the two or more words near the determined single word or the determined two or more words.

According to an embodiment, there may be provided a computer readable recording medium storing a program configured to execute a method for recognizing a character displayed on a display of an electronic device, the method comprising displaying a user interface including text having a plurality of words, detecting a first position of an external object on or adjacent the display, determining a single word at least partially based on the first position, providing a translation of the single word in a first mode, detecting a second position of the external object on or adjacent the display, determining two or more words at least partially based on the second position, and providing a translation of the two or more words in a second mode.

As is apparent from the foregoing description, according to an embodiment, an electronic device may take advantage of various text-recognition techniques together in recognizing characters displayed on the display, thus enabling text recognition in a more accurate and efficient way.

According to an embodiment, an electronic device may randomly select target characters of translation and in particular enables an easier translation of words, phrases, or sentences contained in text displayed on the display of the electronic device based on a user input by an external object.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a housing;
a touchscreen display exposed through a portion of the housing;
a processor electrically connected to the touchscreen display; and
a memory electrically connected with the processor, wherein the memory stores instructions to, when the electronic device is operated, enable the processor to:
display a user interface including text having a plurality of words,
detect a first position of an external object on or adjacent the touchscreen display,
determine a single word at least partially based on the first position,
provide a translation of the single word in a first mode,
detect a second position of the external object on or adjacent the touchscreen display,
determine two or more words at least partially based on the second position, and
provide a translation of the two or more words in a second mode.

2. The electronic device of claim 1, wherein the plurality of words form at least one phrase or sentence, and wherein the memory further stores instructions to, when the electronic device is operated, enable the processor to:
determine the at least one phrase or sentence at least partially based on the second position, and
provide a translation of the determined phrase or sentence in the user interface in the second mode.

3. The electronic device of claim 1, wherein the user interface includes a virtual button configured to switch between the first mode and the second mode.

4. The electronic device of claim 1, wherein the memory further stores information regarding a threshold for at least one of a duration of a touch input to enable the electronic device to differentiate between a first user input setting the electronic device to the first mode and a second user input setting the electronic device to the second mode, a strength of the touch input, or a distance within which a hovering input is detected.

5. The electronic device of claim 1, wherein the external object includes a stylus pen.

6. The electronic device of claim 5, wherein the housing includes a structure configured to receive the stylus pen.

7. The electronic device of claim 1, wherein the memory further stores instructions to, when the electronic device is operated, enable the processor to:
after detecting the external object contacting the touchscreen display, display a menu near a word in the text, and
after detecting the external object approaching the touchscreen display without contacting the touchscreen display, display the translation of the single word in the first mode or display the translation of the two or more words in the second mode.

8. The electronic device of claim 7, wherein the menu includes at least one of a select all item, a copy item, a paste item, or a share item.

9. The electronic device of claim 1, wherein the memory further stores instructions to, when the electronic device is operated, enable the processor to display a pop-up window including the translation of the single word or the translation of the two or more words near the determined single word or the determined two or more words.

10. The electronic device of claim 1, wherein the memory further stores instructions to, when the electronic device is operated, enable the processor to:
identify a position on the touchscreen display corresponding to the first position,
determine the single word or the two or more words included in the text is of an image type or a text type,
generate an image corresponding to the determined single word or two or more words and then extract first text from the generated image using an optical character recognition (OCR) scheme, and
provide a translation of the extracted first text.

11. The electronic device of claim 10, wherein the memory further stores instructions to, when the electronic device is operated, enable the processor to:
when the type of the text is the text type, extract second text related to the text from an application configured to display the text at the identified position, and
obtain third text corresponding to the first text from the second text, in which an error of the first text is corrected based on the third text.

12. The electronic device of claim 11, wherein the memory further stores instructions to, when the electronic device is operated, enable the processor to:
when the third text includes a currency unit, provide a translation of the currency unit based on a currency unit of a country corresponding to a target language for the translation of the single word or the two or more words, and
when the third text includes a measuring unit, provide a translation of the measuring unit based on a measuring unit of the country corresponding to the target language for the translation of the single word or the two or more words.

13. A method for recognizing a character displayed on a touchscreen display of an electronic device, the method comprising:
displaying a user interface including text having a plurality of words;
detecting a first position of an external object on or adjacent the display;
determining a single word at least partially based on the first position;
providing a translation of the single word in a first mode;
detecting a second position of the external object on or adjacent the display;
determining two or more words at least partially based on the second position; and
providing a translation of the two or more words in a second mode.

14. The method of claim 13, wherein the plurality of words form at least one phrase or sentence, and wherein the method further comprises:
determining the at least one phrase or sentence at least partially based on the second position; and
providing a translation of the determined phrase or sentence in the user interface in the second mode.

15. The method of claim 13, wherein the user interface includes a virtual button configured to switch between the first mode and the second mode.

16. The method of claim 13, wherein the electronic device is configured to store, in a memory of the electronic device, a threshold for at least one of a duration of a touch input to enable the electronic device to differentiate between a first user input setting the electronic device to the first mode and a second user input setting the electronic device to the second mode, a strength of the touch input, or a distance within which a hovering input is detected.

17. The method of claim 13, wherein the external object includes a stylus pen.

18. The method of claim 17, wherein a housing of the electronic device includes a structure configured to receive the stylus pen.

19. The method of claim 13, further comprising:
after detecting the external object contacting the touchscreen display, displaying a menu near a word in the text; and
after detecting the external object approaching the touchscreen display without contacting the touchscreen display, displaying the translation of the single word in the first mode or display the translation of the two or more words in the second mode.

20. The method of claim 19, wherein the menu includes at least one of a select all item, a copy item, a paste item, or a share item.

21. The method of claim 13, further comprising displaying a pop-up window including the translation of the single word or the translation of the two or more words near the determined single word or the determined two or more words.

22. A computer readable recording medium storing a program configured to execute a method for recognizing a character displayed on a display of an electronic device, the method comprising:
displaying a user interface including text having a plurality of words;
detecting a first position of an external object on or adjacent the display;
determining a single word at least partially based on the first position;
providing a translation of the single word in a first mode;
detecting a second position of the external object on or adjacent the display;
determining two or more words at least partially based on the second position; and
providing a translation of the two or more words in a second mode.
